(19) United States
(12) Patent Application Publication
(10) Pub. No.: US 2011/0266945 A1
(43) Pub. Date: Nov. 3, 2011

(54) DISPLAY ELEMENT

(75) Inventor: Akihito Hisamitsu, Kanagawa (JP)

(73) Assignee: KONICA MINOLTA HOLDINGS, INC., Tokyo (JP)

(21) Appl. No.: 13/129,445

(22) PCT Filed: Oct. 28, 2009
(86) PCT No.: PCT/JP2009/068477

§ 371 Date: May 16, 2011

(30) Foreign Application Priority Data
Nov. 18, 2008 (JP) 2008-294203

(51) Int. Cl. H01J 1/63

(52) U.S. Cl. 313/504

(57) ABSTRACT

Disclosed is a display element that is capable of implementing a black-and-white display as well as a full-color display with a simple member configuration, and has improved rewriting speed when colors other than black and white are displayed. This display element is characterized in that the display element contains between a pair of opposing electrodes an electrolyte and a compound expressed by Formula (L); said electrolyte contains a metallic salt compound and a mercapto compound expressed by Formula (G); the acidity of said electrolyte is 5.0 or more and 9.0 or less; and by means of the driving operation of the opposing electrodes, white is displayed, black is displayed, and colors other than black are displayed.

### CROSS REFERENCE TO RELATED APPLICATIONS

This is a U.S. national stage application of International Application No. PCT/JP2009/068477, filed on Oct. 28, 2009 Priority under 35 U.S.C. 119(a) and 35 U.S.C. 365(b) is claimed from Japanese Application No. 2008-294203, filed Nov. 18, 2008, the disclosure of which is also incorporated herein by reference.

### TECHNICAL FIELD

The present invention relates to a novel electrochemical display element.

### BACKGROUND

Recently, along with enhancement of the operating speed of personal computers, the spread of network infrastructure, and increased and lower-priced data storage, data of documents or image, which were conventionally printed on paper, can be received simply as electronic information so that opportunities to read such electronic information have notably increased.

There were used, as a means for reading electronic information, conventional liquid crystal displays or CRTs and recent emission type displays, such as organic electroluminescence displays. Specifically, when electronic data is document data, it is necessary to notice this reading means over a relatively long period of time. It is hard to say that such an action is a kindly means to humans. There are generally known disadvantages of emission type displays such that flickering tires human eyes, they are awkward to carry about, the reading posture is restricted, it is necessitated to gaze at a stationary picture plane, and electric power consumption increases when reading over a long time.

As a display means to redeem the foregoing disadvantages is known a (memory type) reflective display which employs external light and does not consume electrical power for image retention. However, based on the reasons below, it is hard to say that such displays provide sufficient performance.

For instance, a system using a polarizing plate such as a reflective liquid crystal display exhibits a relatively low reflectance of around 40%, resulting in difficulty in displaying whiteness and methods of preparing constituent members are not necessarily simple. A polymer asperse liquid crystal display requires a relatively high voltage and employment of the difference in refractive index between organic compounds does not result in images with sufficient contrast. A polymer networked liquid crystal display has problems such that it requires a relatively high voltage and a complex TFT circuit to enhance memory. An electrophoretic display element needs relatively high voltage of more than 10 V, and there is a concern of durability of the electrophoretic particles, due to their tendency to coagulate.

There are known, as a display system to overcome these disadvantages of the foregoing systems, an electrochromic display element (hereinafter, referred to as an EC method) employing an electrochromic compound, and an electrodeposition method (hereinafter, referred to as an ED method) utilizing dissolution and deposition of a metal or a metal salt. The EC method enabling full color display at a low voltage of not more than 3 V exhibits advantages such as simple cell configuration and excellent while color quality. The ED method, which can be driven at a relatively low voltage of not more than 3 V, also exhibits advantages such as simple cell configuration and being superior in black and white contrast as well as in black color quality. There are disclosed various methods (refer to Patent Documents 1-5, for example).

As the results of the investigation to carry out display of a color other than black and white, by arranging an electrochromic compound in an ED display element, the present inventor revealed that an EC method display has many advantages, for example, a bright white display, a high contrast black and white display and a full color display can be conducted with a simple element structure, although rewriting speed of a color other than black and white is not high enough

### PRIOR ART DOCUMENTS

### Patent Documents

Patent Document 1: WO No. 2004/068231

Patent Document 2: WO No. 2004/067673

Patent Document 3: U.S. Pat. No. 4,240,716

Patent Document 4: Japanese Patent No. 3428603

Patent Document 5: Japanese Patent Application Publication Open to Public Inspection (hereafter referred to as JP-A) No. 2003-241227

### DISCLOSURE OF THE INVENTION

### Problems to be Solved by the Invention

In view of the foregoing problems, the present invention was achieved. An object of the present invention is to provide a display element which enables a black and white display and a full-color display with a simple element structure, while attaining an improved rewriting speed of a color other than black and white.

### Means to Solve the Problems

The above-described object of the present invention is accomplished by the following structures.

1. A display element comprising at least an electrolyte and a compound represented by following Formula (L) between opposing electrodes,
wherein

the electrolyte comprises a metal salt compound and a mercapto compound represented by following Formula (G),

an acidity of the electrolyte is 5.0 or more but 9.0 or less, and

a white display, a black display and a color display other than the black display are conducted by a driving operation employing the opposing electrodes:

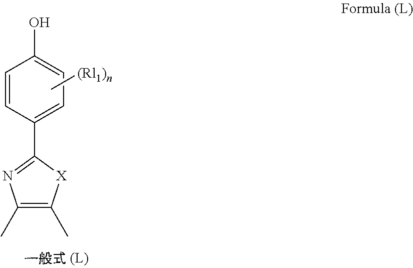

wherein Rl₁ represents a halogen atom, an aliphatic group, an aliphatic oxy group, an acylamino group, a carbamoyl group, an acyl group, a sulfonamide group or a sulfamoyl group, n represents an integer of 1 to 4, Rl₂ represents an aromatic group or an aromatic heterocycle group, Rl₃ represents a hydrogen atom, an aliphatic group, an aromatic group or an aromatic heterocycle group, and X represents >N-Rl₄, an oxygen atom or a sulfur atom, wherein Rl₄ represents a hydrogen atom, an aliphatic group, an aromatic group, a heterocycle group or an acyl group,

wherein a group represented by one of Rlᵢ to Rl₄ may further be substituted with an arbitrary substituent, and

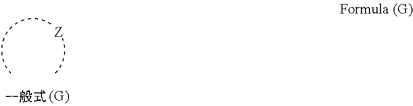

wherein Z represents a heterocycle containing nitrogen, n represents an integer of 0 to 5, and Rg₂₁ represents a halogen atom, an alkyl group, an aryl group, an alkyl carbonamide group, an aryl carbonamide group, an alkyl sulfonamide group, an aryl sulfonamide group, an alkoxy group, an aryl oxygroup, an alkylthio group, an aryl thio group, an alkyl carbamoyl group, an aryl carbamoyl group, a carbamoyl group, an alkyl sulfamoyl group, an aryl sulfamoyl group, a sulfamoyl group, a cyano group, an alkyl sulfonyl group, an aryl sulfonyl group, an alkoxy carbonyl group, an aryl oxycarbonyl group, an alkyl carbonyl group, an aryl carbonyl group, an acyloxy group, a carboxyl group, a carbonyl group, a sulfonyl group, an amino group, a hydroxy group or a heterocycle group, wherein, when n is 2 or more, the Rg₂₁ groups may be the same or different, and may be combined with each other to form a condensed ring.
2. The display element of Item 1, wherein the acidity of the electrolyte is 6.0 or more but 8.0 or less.
3. The display element of Item 1 or 2, wherein the display element comprises a compound represented by Fonnula (A) between the opposing electrodes:

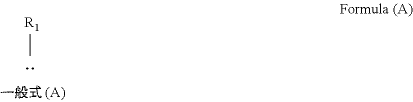

wherein R₁, R₂ and R₃ each represent a substituted or non-substituted hydrocarbon group, wherein R₁, R₂ and R₃ may be the same or different.
4. The display element of any one of Items 1 to 3, wherein the display element comprises a polymer having an amino group between the opposing electrodes.
5. The display element of any one of Items 1 to 4, wherein the display element comprises an amine compound carried on particles between the opposing electrodes.
6. The display element of any one of Items 3 to 5, wherein at least one of the compound represented by Formula (A), a polymer having an amino group and an amine compound carried on particles is fixed at an area other than surfaces of the opposing electrodes.

### Effect of the Invention

According to the present invention, a display element which enables a black and white display and a full-color display with a simple element structure, while attaining an improved rewriting speed of a color other than black and white was obtained.

### DESCRIPTION OF THE PREFERRED EMBODIMENTS

Next, the preferred embodiments of the present invention will be described in detail.

After considerable effort during intensive studies, the inventor has found out that a display element which enables a black and white display and a color display with a simple element structure, while attaining an improved rewriting speed of a color other than black and white can be obtained by employing a display element characterized in that the display element comprises at least an electrolyte and a compound represented by following Formula (L) between opposing electrodes, wherein the electrolyte comprises a metal salt compound and a mercapto compound represented by following Formula (G); an acidity of the electrolyte is 5.0 or more but 9.0 or less; and a white display, a black display and a color display other than the black display are conducted by a driving operation employing the opposing electrodes, resulting in achievement of the present invention.

Next, the display element of the present invention will be described in detail.

### <<Basic Structure of the Display Element>>

In the display element of the present invention, a white display, a black display and a color display other than the black display and the white display can be reversibly changed by applying voltages of both polarities of positive and negative on opposing electrodes of the display element containing at least an electrolyte having an acidity of 5.0 or more but 9.0 or less, and a compound represented by Formula (L) between the opposing electrodes.

### <<Electrolyte>>

An electrolyte described in the present invention is called a substance which is dissolved in a solvent such as water to produce a solution exhibiting ion conductivity (hereinafter referred to as “narrowly-defined electrolyte”), but in the description of the present invention, a mixture prepared by incorporating another metal or compound regardless of an electrolyte or a non-electrolyte in a narrowly-defined electrode is referred to as an electrolyte (“broadly-defined electrode”).

The electrolyte according to the present invention is characterized in that the electrolyte contains at least a metal salt compound and a mercapto compound represented by Formula (G) according to the present invention, and that the acidity of the electrolyte is 5.0 or more but 9.0 or less. The acidity of the electrolyte is defined as a pH value measured at 25° C. of a water phase obtained by adding the same amount of pure water as an amount of the electrolyte to the electrolyte, followed by stirring.

### [Metal Salt Compound]

A metal salt compound of the present invention may be any compound, provided that it is a salt containing a kind of metal capable of dissolving and depositing via driving operation of a pair of facing electrodes on at least one of the foregoing electrodes. Examples of preferred kinds of metals include silver, bismuth, copper, nickel, iron, chromium, and zinc. Silver and bismuth are specifically preferable.

### <Silver Salt Compound>

A silver salt compound in the present invention means a generic designation of silver and compounds containing silver in the chemical structure thereof, including, for example, silver oxide, silver sulfide, metal silver, silver colloidal particles, silver halides, silver complex compounds, compounds of silver ion. The phase state species such as a solid state, a solubilization state to liquid, or a gas state and the charging state species such as the neutral, anionic, or cationic state are not specifically taken into account.

In the display element of the present invention, usable are commonly known silver salt compounds such as silver iodide, silver chloride, silver bromide, silver oxide, silver sulfide, silver citrate, silver acetate, silver behenate, silver p-toluenesulfonate, silver trifluoromethanesulfonate, silver salts with a mercapto-compounds, and silver complexes with an iminodiacetic acids. Of these, silver salts containing no nitrogen atom which has a nature to coordinate halogen, carboxylic acid or silver are preferably used. For example, silver p-toluenesulfonate is preferably used.

The concentration of metal ions contained in an electrolyte of the present invention is preferably 0.2 mol/kg [Metal] 2.0 mol/kg. When the metal ion concentration is 0.2 mol/kg or more, a silver solution having sufficient concentration is realized to achieve a desired driving rate. In the case of 2 mol/kg or less, deposition is suppressed, and stability of an electrolytic solution during low temperature storage is enhanced.

### [Concentration Ratio of Halogen Ion to Metal Ion]

In a display element of the present invention, when the molar concentration of halogen ions or halogen atoms contained in an electrolyte is expressed as [X] (mol/kg), and the total molar concentration of silver or silver in a compound containing silver in its chemical structure is expressed as [Metal] (mol/kg), the condition specified by the following Expression (1) is preferably satisfied:

0≦[X]/[Metal]≦0.1 Expression (1)

The halogen atom in the present invention means an iodine atom, a chlorine atom, a bromine atom or a fluorine atom. When [X]/[Metal] is larger than 0.1, the reaction of X′→X₂ is induced during the redox reaction of a metal and then the X₂ is readily subjected to cross-oxidation with the deposited metal, resulting in dissolution of the deposited metal, which produces one factor to decrease memory capability. Therefore, the molar concentration of a halogen atom is preferably as small as possible, compared to the molar concentration of metallic silver. In the present invention, the relationship of 0≦[X]/[Metal]≦0.001 is more preferable. When halogen ions are added, with regard to the halogen species, the total molar concentration of each of the halogen species preferably satisfies the relationship: [I]<[Br]<[Cl]<[F] from the viewpoint of memory property enhancement

### [Mercapto Compound Represented by Formula (G)]

In the electrolyte according to the present invention, it is one of the features that a mercapto compound represented by Formula (G) is contained as a metal salt solvent for promoting the melting/precipitating of a metal salt (specifically a silver salt) in addition to the above-mentioned metallic compound.

Hereafter, the mercapto compound represented by Formula (G) will be described.

In the above-mentioned Formula (G), Z represents a heterocycle containing nitrogen, and n is an integer of 0-5. Rg₂₁ is a halogen atom, an alkyl group, an aryl group, an alkylcarbonamide group, an arylcarbonamide group, an alkyl sulfonamide group, an aryl sulfonamide group, an alkoxy group, the aryloxygroup, an alkylthio group, an arylthio group, an alkyl carbamoyl group, the aryl carbamoyl group, a carbamoyl group, an alkylsulfamoyl group, an arylsulfamoyl group, a sulfamoyl group, a cyano group, an alkylsulfonyl group, the arylsulfonyl group, an alkoxycarbonyl group, an aryloxycarbonyl group, an alkyl carbonyl group, an aryl carbonyl group, an acyloxy group, a carboxyl group, a carbonyl group, a sulfonyl group, an amino group, a hydroxy group or a heterocycle group, and when n is two or more, each Rg₂₁ may be the same or different, or may be connected with each other to form a condensed ring.

Examples of a heterocycle containing nitrogen represented by Z of Formula (G) include a tetrazole ring, a triazole ring, an oxydiazole ring, a thiadiazole ring, an indole ring, an oxazole ring, a benzoxazole ring, a benzothiazole ring, a benzoselenazole ring and a naphthoxazole ring.

As for Rg₂₁ of Formula (G), examples of a halogen atom include a fluorine atom, a chlorine atom, a bromine atom and an iodine atoms; examples of an alkyl group include each group of methyl, ethyl, propyl, i-propyl, butyl, t-butyl, pentyl, cyclopentyl, hexyl, cyclohexyl, octyl, dodecyl, hydroxyethyl, methoxy ethyl, trifluoro methyl and benzyl; examples of an aryl group include phenyl and naphthyl, examples of an alkylcarbonamide group include acetylamino and propionylamino and butyroylamino; examples of an arylcarbonamide group include benzoylamino; examples of an alkylsulfonamide group include a methane sulfonylamino group and an ethanesulfonyl amino group; examples of an arylcarbonamide group include a benzenesulfonylamino group and a toluenesulfonylamino group; examples of an aryloxy group include a phenoxy group; examples of an alkylthio group include a methylthio group, an ethylthio group and a butylthio group; examples of an arylthio group include a phenylthio group and a tolylthio group; examples of an alkylcarbamoyl group include each group of methylcarbamoyl, dimethylcarbamoyl; ethylcarbamoyl, diethylcarbamoyl, dibutylcarbamoyl, piperidylcarbamoyl and morpholylcarbamoyl; examples of an arylcarbamoyl group include each group of phenylcarbamoyl, methylphenylcarbamoyl, ethylphenyl carbamoyl and benzylphenylcarbamoyl; examples of an alkylsulfamoyl group include each group of methylsulfamoyl, dimethylsulfamoyl, ethylsulfamoyl, diethylsulfamoyl, dibutylsulfamoyl, piperidylsulfamoyl and morpholylsulfamoyl; examples of an arylsulfamoyl group include each group of phenylsulfamoyl, methylphenyl sulfamoyl, ethylphenyl sulfamoyl and a benzylphenyl sulfamoyl; examples of an alkylsulfonyl group include a methanesulfonyl group and an ethanesulfonyl group; examples of an arylsulfonyl group include each group of phenylsulfonyl, 4-chlorophenylsulfonyl and p-toluenesulfonyl; examples of an alkoxycarbonyl group include each group of methoxycarbonyl, ethoxycarbonyl and butoxycarbonyl; examples of an aryloxycarbonyl group include a phenoxycarbonyl group; examples of an alkcarbonyl group include each group of acetyl, propionyl and butyroyl; examples of an arylcarbonyl group include a benzoyl group and an alkylbenzoyl group; examples of an acyloxy group include each group of acetyl oxy, propionyloxy and the butyroyloxy; and examples of a heterocycle group include an oxazole ring, a thiazole ring, a triazole ring, a selenazole ring, a tetrazole ring, an oxydiazole ring, a thiadiazole ring, a thiazin ring, a triazine ring, a benzoxazole ring, a bezthiazole ring, an indolenine ring, a benzselenazole ring, a naphththiazole ring, a triazaindolizine ring, a diazaindolizine ring and a tetra-azainodolizine ring. These substituents contain those further having a substituent.

Next, preferable specific examples of a mercapto compound represented by Formula (G) will be shown, however, the present invention is not limited to these compounds.

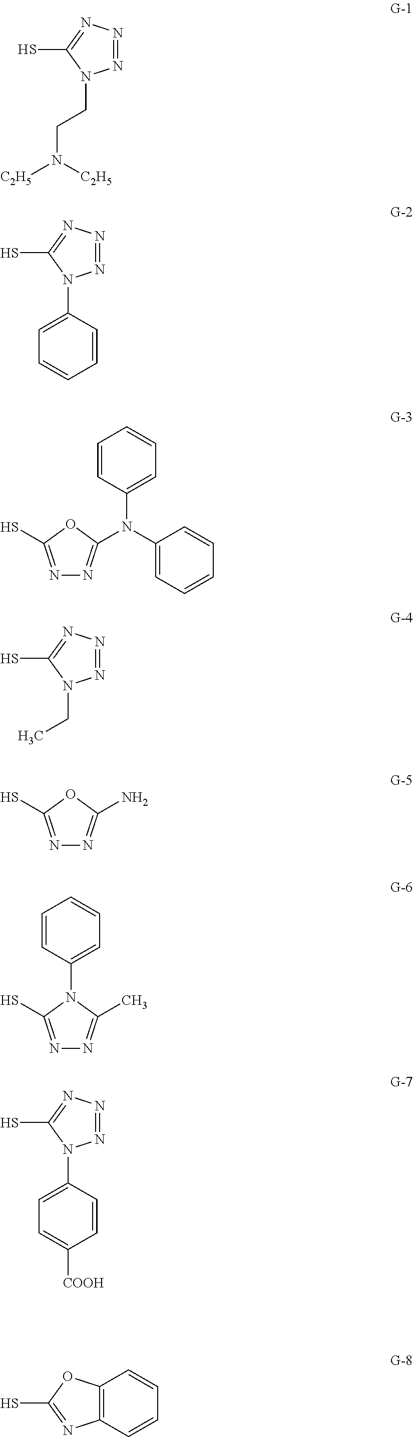

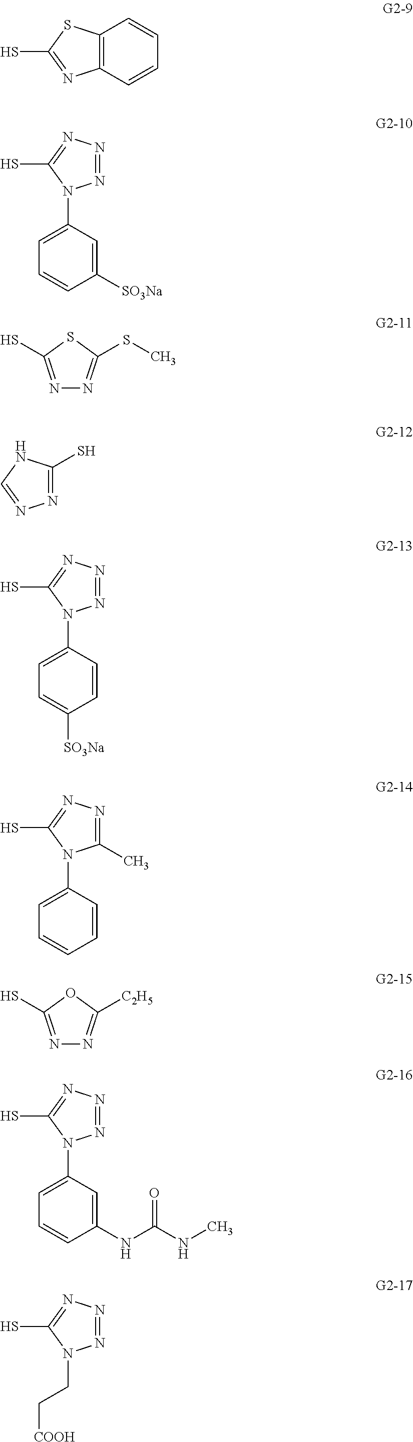

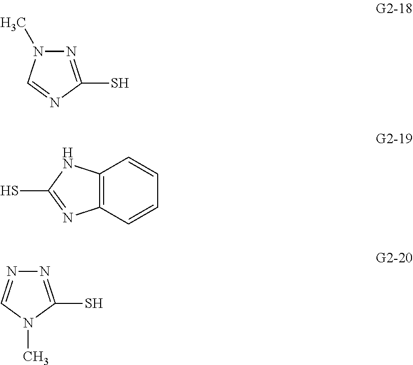

Among the above exemplified compounds, exemplified compounds G-12, G-18, G-19 and G-20 are specifically preferable in view of fully achieving the objective effect of the present invention.

One of ordinary skill in the art would be able to synthesize the mercapto compounds represented by Formula (G) of the present invention according to a conventionally well-known method. Also, those compounds are commercially available in the market

### [Acidity of Electrolyte]

It is one of the features of the present invention that the acidity of the electrolyte is 5.0 or more but 9.0 or less, and is preferably 6.0 or more but 8.0 or less. By making the acidity of the electrolyte 5.0 or more, the rewriting speed at the time of performing a white display and a color display other than black can be increased.

This would be because the coloring is expected to be easier when the concentration of H⁺ ions in the electrolyte is low, namely, the acidity is high, since the imidazole dye represented by Formula (L) of the present invention is considered to emit H⁺ ions when the dye is colored (namely, displaying a color). Alternatively, when the concentration of Fr ions becomes too low, namely, the acidity value is too large, specifically, when the acidity exceeds 9.0, it becomes difficult to erase the color, and occasionally the display element becomes difficult to drive by applying a voltage between the opposing electrodes. This would be because, since the imidazole dye represented by Formula (L) of the present invention is considered to take in H⁺ ions when the color is erased, as the result, it is deduced that the color fading becomes difficult when the concentration of H⁺ ions becomes too low, namely, the acidity becomes too high. Therefore, the improvement in the rewriting speed of the color display was achieved by adjusting the acidity of the electrolyte 5.0 or more but 9.0 or less, and preferably 6.0 or more but 8.0 or less.

In the present invention, any method to adjust the acidity of an electrolyte may be used, however, when the electrolyte is an organic solvent system, it is preferable to use an organic base and it is preferable to use an amine compound. Specifically, amine compounds cited in following (1) to (3) are preferable to use.

### (1) Compound Represented by Formula (A)

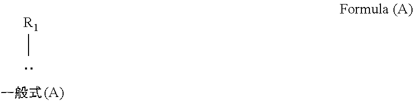

In Formula (A), R₁, R₂, and R₃ each represent a substituted or non-substituted hydrocarbon, provided that R₁, R₂, and R₃ may be the same or different.

As examples of a hydrocarbon group represented by R₁, R₂ or R₃, an alkyl group, an alkyl halide group, a cycloalkyl group, and an aromatic hydrocarbon group are cited. More specifically, examples of an alkyl group include a methyl group, an ethyl group, a propyl group, an isopropyl group, an amyl group, a hexyl group, an octyl group, a decyl group, a dodecyl group and an octadecyl group; examples of an cycloalkyl group include a cyclohexyl group; examples of an aromatic hydrocarbon group include an aryl group and an aralkyl group and, specifically, a phenyl group, a tolyl group, a naphthyl group, a benzyl group and a phenylethyl group; and examples of a substituent of the hydrocarbon group inclucle an alkyl group (for example, a methyl group and an ethyl group), acylamino group (for example, an acetylamino group, a propanoyl amino group, an i-butanoylamino group, an n-butanoylamino group, a benzoylamino group and m-sulfobenzoylamino group, an alkoxycarbonyl amino group (for example, a methoxycarbonylamino group and an ethoxycarbonylamino group), an aryloxycarbonyl amino group (for example, a phenoxycarbonyl amino group), an alkoxycarbonyl group (for example, an ethoxycarbonyl group), an aryloxycarbonyl group (for example, a phenoxycarbonyl group), an ureido group (for example, a methylureido group and a phenyl ureido group), a sulfonylamino group (for example, a methanesulfonamide group, an ethane sulfonamide group and a benzenesulfonamide group), a carbamoyl group (for example, a methylcarbamoyl group and a phenyl carbamoyl group), and a halogen atom (for example, a fluorine atom and a chlorine atom).

Furthermore, the hydrocarbon group represented with R₁, R₂, or R₃ may have a substituent. Examples of a substituent include halogen atoms (for example, a fluorine atom, a chlorine atom, etc.), an alkyl group (for example, methyl, ethyl, i-propyl, hydroxyethyl, and methoxymethyl, trifluoro methyl and t-butyl), a cycloalkyl group (for example, cyclopentyl and cyclohexyl), an aralkyl group (for example, benzyl and 2-phenethyl, etc.), an aryl group (for example, phenyl, naphthyl, p-tolyl, and p-chlorophenyl), an alkoxy group (for example, methoxy and ethoxy, i-propoxy and butoxy), an aryloxy group (for example, phenoxy), a cyano group, a heterocycle group (for example, pyrrole, pyrrolidyl, pyrazolyl, imidazolyl, pyridyl, benzimidazolyl, benzthiazolyl and benzoxazolyl).

Examples of a compound represented by Formula (A) include trimethylamine, triethylamine, tripropylamine, tributylamine, triisopropanolamine, triethanolamine, tris(hydroxymethyl)aminomethane and N,N-dimethylaniline.

### (2) Polymer Which Has an Amino Group

In the present invention, a polymer which has a monomer unit containing an amino group can be cited as a means to adjust the acidity of an electrolyte.

Examples of a monomer which has an amino group include N,N-diethylaminoethyl methacrylate, N,N-dimethylaminoethyl acrylate, N,N-dimethylaminoethyl methacrylate, polybutadieneurethane acrylate, N,N-dimethylaminopropyl acrylamide, N,N-dimethylacrylamide, acryloylmorpholine, N-isopropylacrylamide and N,N-diethylacrylamide.

Further, a polymer which has an amino group can be obtained as a product available on the market. For example, there are cited 1) POLYMENTS SERIES produced by NIPPON SHOKUBAI Co., Ltd., which is an aminoethyl modified acrylic polymer containing an amine group having polyethyleneimine grafted as the side chain, for example, NK-350 (having an average molecular weight of 100,000 and an amine value of 0.6-1.0 mmol/g.solid), NK-380 (having an average molecular weight of 100,000 and an amine value of 0.7-1.3 mmol/g solid); 2) PAA SERIES produced by NITTO BOSEKI Co., Ltd., which is a POLYALLYLAMINE® having only a primary amine as a side chain, for example, PAA-01 (having an average molecular weight of around 1000 and an pH of around 11), PAA-03 (having an average molecular weight of around 3000 and an pH of around 11), PAA-05 (having an average molecular weight of around 5000 and an pH of around 11) and PAA-15 (having an average molecular weight of around 15000 and an pH of around 11).

### (3) Amine Compound Carried on Particles

In the present invention, organic or inorganic particles which carry an amine compound on the particle surface may be used as a means to adjust the acidity of the electrolyte.

Examples of an amine compound carried of particles include porous polystyrene particles carrying, for example, piperidine, pyridine, imidazole or piperazine, and porous silica particles carrying, for example, piperidine, pyridine, imidazole or piperazine.

The above-described amine compounds according to the present invention, for example, the compound represented by Formula (A), the polymer having an amino group and the amine compounds carried on particles, may be used by being dissolved or being dispersed in an electrolyte. It is further preferable that these amine compounds are used by being fixed in an area other than the surfaces of a pair of opposing electrodes, since these amine compounds tend not to be electrochemically oxidized or reduced.

### [Supporting Electrolyte]

As a supporting electrolyte usable in a display element of the present invention, a salt, an acid, or an alkali commonly usable in the field of electrochemistry or batteries can be used.

The salt is not specifically limited, and usable examples thereof include an inorganic ion salt such as an alkali metal salt or an alkaline-earth metal salt; a quaternary ammonium salt; a cyclic quaternary ammonium salt; and a quaternary phosphonium salt.

Specific examples of salts include metal salts such as a Li salt, a Na salt and a K salt having a counter anion, selected from a halogen ion, SCN⁻, ClO₄⁻, BF₄⁻, CF₃SO₃⁻, (CF₃SO₂)₂N⁻, (C₂F₅SO₂)₂N⁻, PF₆⁻, AsF₆⁻, CH₃COO⁻, CH₃(C₆H₄)SO₃⁻, and (C₂F₅SO₂)₃C⁻.

Further, cited is a quaternary ammonium salt having a counter anion, selected from a halogen ion, SCN⁻, ClO₄⁻, BF₄⁻, CF₃SO₃⁻, (CF₃SO₂)₂N⁻, (C₂F₅SO₂)₂N⁻, PF₆⁻, AsF₆⁻, CH₃COO⁻, CH₃(C₆H₄)SO₃⁻, and (C₂F₅SO₂)₃C⁻. Specific examples thereof include (CH₃)₄NBF₄, (C₂H₅)₄NF₄, (n-C₄H₉)₄NBF₄, (C₂H₅)₄NBr, (C₂H₅)₄NClO₄, (n-C₄H₉)₄NClO₄, CH₃(C₂H₅)₃NBF₄, (CH₃)₂(C₂H₅)₂NBF₄, (CH₃)₄NSO₃CF₃, (C₂H₅)₄NSO₃CF₃, and (n-C₄H₉)₄NSO₃CF₃.

Further, other examples are listed below.

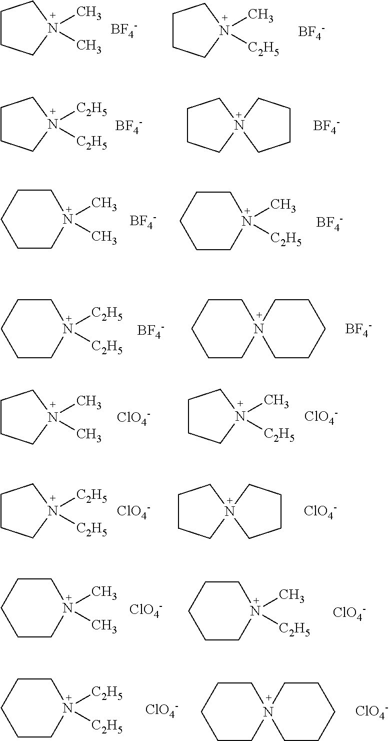

Further, a phosphonium salt having a counter anion, selected from a halogen ion, SCN⁻, ClO₄⁻, BF₄⁻, CF₃SO₃⁻, (CF₃SO₂)₂N⁻, (C₂F₅SO₂)₂N⁻, PF₆⁻, AsF₆⁻, CH₃COO⁻, CH₃(C₆H₄)SO₃⁻, and (C₂F₅SO₂)₃C⁻, and specific examples thereof include (CH₃)₄PBF₄, (C₂H₅)₄PBF₄, (C₃H₇)₄PBF₄, (C₄H₉)₄PBF₄ and so forth. Further, a mixture of these is preferably usable.

As a supporting electrolyte of the present invention, a quaternary ammonium salt is preferable and a quaternary spiroammmonium salt is specifically preferable. Further, as a counter anion, ClO₄⁻, BF₄⁻, CF₃SO₃⁻, (C₂F₅SO₂)₂N⁻, and PF₆⁻ are preferable and BF₄⁻ is specifically preferable.

The consumption amount of an electrolyte salt is arbitrary, but the electrolyte salt commonly exists at an upper limit of 20 mol/L or less, preferably at an upper limit of 10 mol/L or less, and more preferably at an upper limit of 5 mol/L or less. The lower limit is commonly 0.01 mol/L or more, preferably 0.05 mol/L or more, and more preferably 0.1 mol/L or more.

Further, a solid electrolyte can contain therein the following compounds exhibiting electronic or ionic conductivity.

Examples thereof include fluorinated vinyl based polymers containing a perfluorosulfonic acid, polythiophene, polyaniline, polypyrrole, triphenylamines, polyvinylcarbazoles, polymethylphenylsilanes, calcogenides such as Cu₂S, Ag₂S, Cu₂Se, and AgCrSe₂, fluorine compounds such as CaF₂, PbF₂, SrF₂, LaF₃, TlSn₂F₅, and CeF₃, lithium salts such as Li₂SO₄ and Li₄SiO₄ and compounds such as ZrO₂, CaO, Cd₂O₃, HfO₂, Y₂O₃, Nb₂O₅, WO₃, Bi₂O₃, AgBr, AgI, CuCl, CuBr, CuBr, CuI, LiI, LiBr, LiCl, LiAlCl₄, LiAlF₄, AgSBr, C₅H₅NHAg₅I₆, Rb₄Cu₁₆I₇Cl₁₃, Rb₃Cu₇Cl₁₀, LiN, Li₅NI₂, and Li₆NBr₃.

<<The Compound Represented with a General Formula (L)>>

It is one of the features of the present invention that an imidazole dye represented by above-mentioned Formula (L) is used as an electrochromic compound (hereafter, referred to as an EC compound or an EC dye) aiming at a color display.

In the above-mentioned Formula (L), Rl₁ represents a halogen atom, an aliphatic group, an aliphatic oxy group, an acylamino group, a carbamoyl group, an acyl group, a sulfonamide group or a sulfamoyl group, n represents an integer of 1 to 4, Rl₂ represents an aromatic group or an aromatic heterocycle group, and Rl₃ represents a hydrogen atom, an aliphatic group, an aromatic group or an aromatic heterocycle group, and X represents >N-Rl₄, an oxygen atom or a sulfur atom, wherein Rl₄ represents a hydrogen atom, an aliphatic group, an aromatic group, a heterocycle group or an acyl group, wherein a group represented by one of Rl1 to Rl₄ may further be substituted by an arbitrary substituent.

Regarding Rh, examples of a halogen atom include a chlorine atom, a bromine atom and an iodine atom; examples of an aliphatic group include an alkyl group (for example, a methyl group, an ethyl group, a propyl group, an isopropyl group, a tert-butyl group, a pentyl group and a hexyl group), a cycloalkyl groups (for example, a cyclohexyl group and a cyclopentyl group), an alkenyl group, a cycloalkenyl group, and an alkynyl group (for example, a propargyl group); examples of an aliphatic oxy group include an alkoxy group for example, a methoxy group, an ethoxy group, a propyloxy group, a pentyl oxygroup, a cyclopentyloxy group, a hexyl oxygroup and a cyclohexyloxy group; examples of an acylamino group include an acetylamino group, a benzoylamino group and a methyl ureido group; examples of a carbamoyl group include an amino carbonyl group, a methylamino carbonyl group, a dimethylamino carbonyl group, a propylamino carbonyl group, a pentylamino carbonyl group, a cyclohexylamino carbonyl group, a phenylamino carbonyl group and a 2-pyridylamino carbonyl group; examples of an aacyl group include an acetyl group, a propionyl group, a butanoyl group, a hexanoil group, a cyclohexanoil group, a benzoyl group and a pyridinoil group; examples of a sulfonamide group include a methane sulfonamide group, an ethane sulfonamide group, a butane sulfonamide group, a hexane sulfonamide group, a cyclohexane sulfonamide group and a benzenesulfonamide group; and examples of a sulfamoyl group include an amino sulfonyl group, the methylamino sulfonyl group, a dimethylamino sulfonyl group, a butyl amino sulfonyl group, a hexyl amino sulfonyl group, a cyclohexyl amino sulfonyl group, a phenylamino sulfonyl group and a 2-pyridyl amino sulfonyl group. As a group represented by Rl₁, an alkyl group (specifically, a branched alkyl group), a cycloalkyl group, an alkyl oxy group, and a cycloalkyl oxy group are preferable.

The numeral n represents an integer of 1-4, however, it is preferable that n=2.

Rl₂ represents an aromatic group or an aromatic heterocycle group, and Rl₃ represents a hydrogen atom, an aliphatic group, an aromatic group, and an aromatic heterocycle group. Examples of an aromatic group represented by Rl₂ or Rl₃ include a phenyl group, a naphthyl group and an anthracenyl group, and examples of an aromatic heterocycle group include a furyl group, a thienyl group, a pyridyl group, a pyridazinyl group, a pyrimidinyl group, a pyrazyl group, a triazyl group, an imidazolyl group, a pyrazolyl group, a thiazolyl group, a benzoimidazolyl group, a benzoxazolyl group, a quinazolyl group, a phthalazinyl group, a pyrrolyl group, 2-quinolyl group and a 1-isoquinolinyl group. Examples of an aliphatic group represented by Rl₃ include an alkyl group (for example, a methyl group, an ethyl group, a propyl group, an isopropyl group, a tert-butyl group, a pentyl group and a hexyl group), a cycloalkyl groups (for example, a cyclohexyl group and a cyclopentyl group), an alkenyl group, a cycloalkenyl group, and an alkynyl group (for example, a propargyl group). As a group represented by Rl₂, a substituted or non-substituted phenyl group, and a 5 or 6 membered heterocycle (for example, a thienyl group, a furyl group, a pyrrolyl group and a pyridyl group) are preferably used. As a group represented by Rl₃, a substituted or non-substituted phenyl group, a 5 or 6 membered heterocycle and an alkyl group are preferably used.

In Formula (L), Rl₂ and Rl₃ may be combined with each other to form a ring structure. The combination of Rl₂ and Rl₃ may a case in which the both groups are a phenyl group which may have a substituent or a heterocycle group which may have a substituent, or a case in which one of the groups is a phenyl group which may have a substituent or a heterocycle group which may have a substituent and the other is an alkyl group which may have a substituent.

X represents >N-Rl₄, an oxygen atom, or a sulfur atom, and is preferably >N-Rl₄. Examples of Rl₄ include a hydrogen atom, an aliphatic group, an aromatic group, a heterocycle group and an acyl group, preferably include a hydrogen atom, an alkyl group, an aromatic group, a heterocycle group and an acyl group, more preferably include a hydrogen atom, an alkyl group having 1-10 carbon atoms, an aryl group having 5-10 carbon atoms and an acyl group, and specifically preferably include a hydrogen atom and an alkyl group having 1-10 carbon atoms.

Provided can be an alkyl group (for example, a methyl group, an ethyl group, a propyl group, an isopropyl group, a t-butyl group, a pentyl group or a hexyl group), a cycloalkyl group (for example, a cyclohexyl group or a cyclopentyl group), an alkenyl group, a cycloalkenyl group, an alkynyl group (for example, a propargyl group), a glycidyl group, an acrylate group, a methacrylate group, an aromatic group (for example, a phenyl group, a naphthyl group or an anthracenyl group), a heterocyclic group (for example, a pyridyl group, a thiazolyl group, an oxazolyl group, an imidazolyl group, a furyl group, a pyrrolyl group, a pyrazinyl group, a pyrimidinyl group, a pyridazinyl group, a selenazolyl group, a sulfolanyl group, a piperidinyl group, a pyrazolyl group or a tetrazolyl group), an alkoxy group (for example, a methoxy group, an ethoxy group, a propyloxy group, a pentyloxy group, a cyclopentyloxy group, a hexyloxy group or a cyclohexyloxy group), an aryloxy group (for example, a phenoxy group), an alkoxylcarbonyl group (for example, a methyloxycarbonyl group, an ethyloxycarbonyl group or a butyloxycarbonyl group), an aryloxycarbonyl group (for example, a phenyloxycarbonyl group), a sulfonamide group (for example, a methane sulfonamide group, an ethane sulfonamide group, a butane sulfonamide group, a hexane sulfonamide group, a cyclohexane sulfonamide group or a benzene sulfonamide group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, a phenylaminosulfonyl group or a 2-pyridylaminosulfonyl group), a urethane group (for example, a methylureide group, an ethylureide group, a pentylureide group, a cyclohexylureide group, a phenylureide group or a 2-pyridylureide group), an acyl group (for example, an acetyl group, a propionyl group, a butanoyl group, a hexanoyl group, a cyclohexanoyl group, a benzoyl group or a pyridinoyl group), a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, a phenylaminocarbonyl group or a 2-pyridylaminocarbonyl group), an acylamino group (for example, an acetylamino group, a benzoylamino group or a methylureide group), an amide group (for example, an acetamide group, a propionamide group, a butanamide, a hexanamide or a benzamide group), a sulfonyl group (for example, a methylsulfonyl group, an ethylsulfonyl group, a butylsulfonyl group, a cyclohexylsulfonyl group a phenylsulfonyl group or a 2-pyridylsulfonyl group), a sulfonamide (for example, a methylsulfonamide group, an octylsulfonamide group, a phenylsulfonamide group or a naphthylsulfonamide group), an amino group (for example, an amino group, an ethylamino group, a dimethylamino group, a butylamino group, a cyclopentylamino group, an anilino group or a 2-pyridylamino group), a halogen atom (for example, a chlorine atom, a bromine atom or an iodine atom), a cyano group, a nitro group, a sulfo group, a carboxyl group, a hydroxyl group or a phosphono group (for example, a phosphonoethyl group, a phosphonopropyl group or a phosphonooxyethyl group). These groups may further be substituted by any of these ones.

In the display element of the present invention, a compound represented by foregoing Formula (L) of the present invention preferably has a group chemically or physically adsorbs onto the electrode surface. The chemical adsorption of the present invention means a relatively strong adsorption state via chemical bonding to the electrode surface, and the physical adsorption of the present invention means a relatively weak adsorption state via van der Walls force acting between the electrode surface and an adsorbed substance. An adsorption group in the present invention is preferably a chemical adsorption group.

In Formula (L). it is preferable that at least one of the groups represented by Rl₁ to Rl₄ has at least one chemical adsorption group selected from —COOH, —P═O(OH)₂, —OP═O(OH)₂ and —Si(OR)₃ (where R represents an alkyl group) as a substructure.

Examples of a compound of an imidazole dye represented by Formula (L) will be shown below, however, the present invention is not limited to these exemplified compounds.

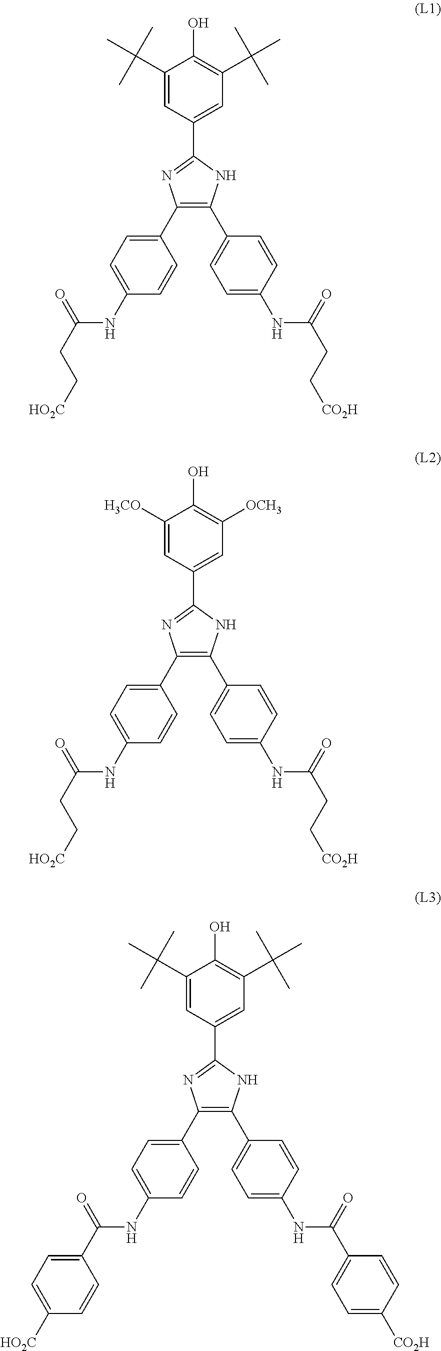

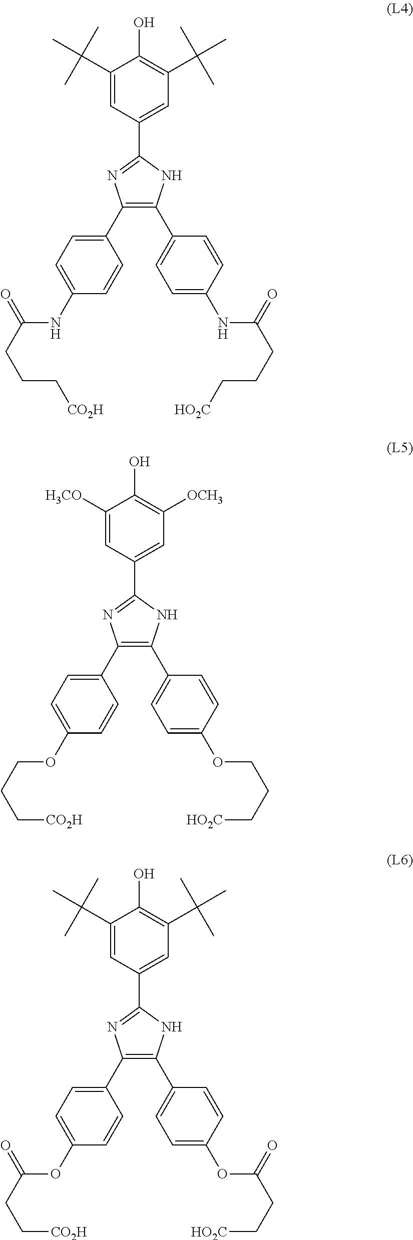

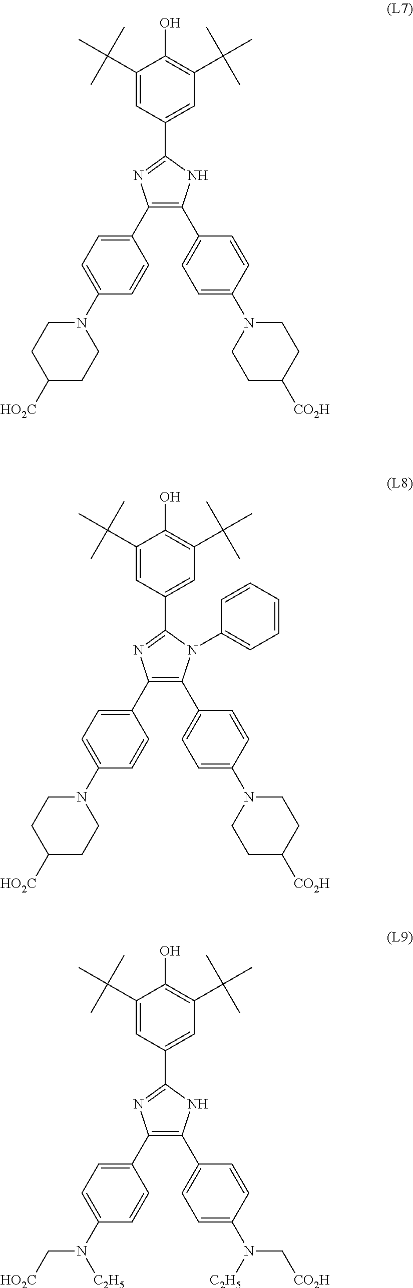

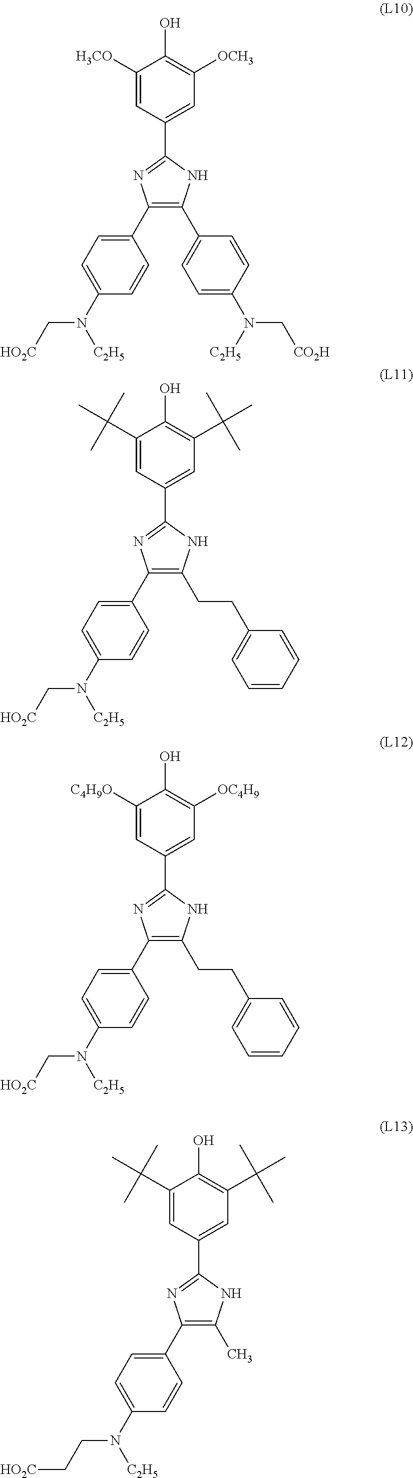

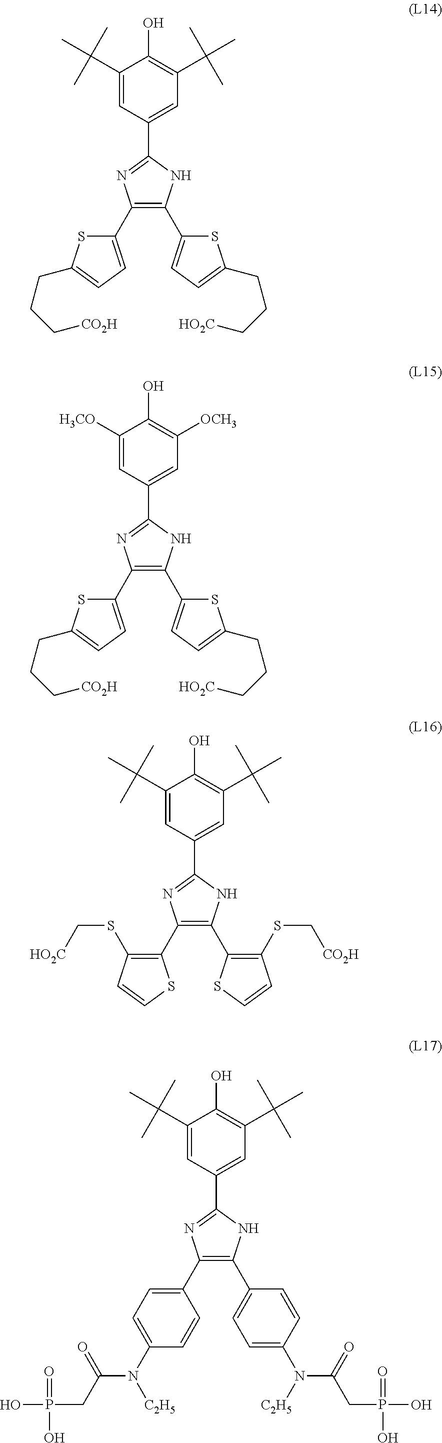

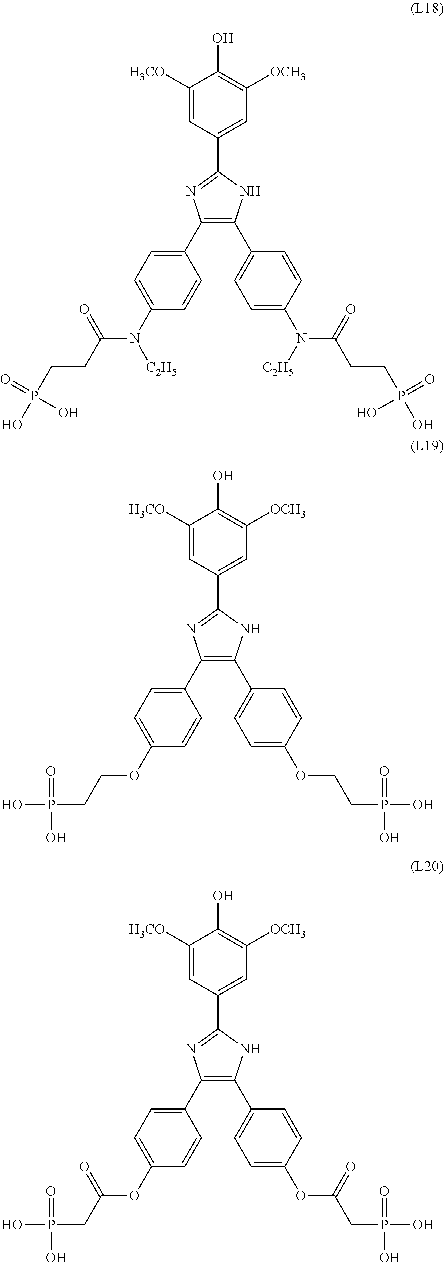

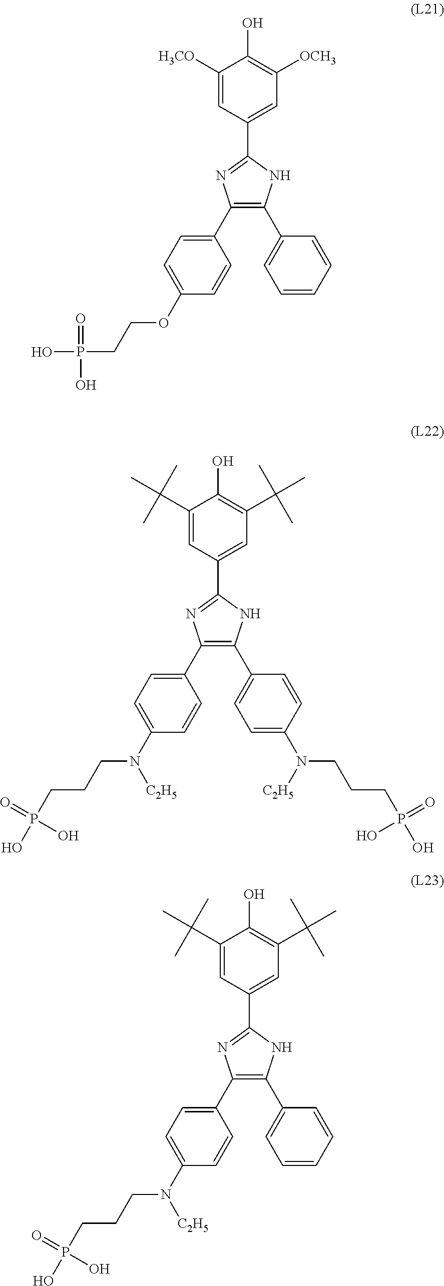

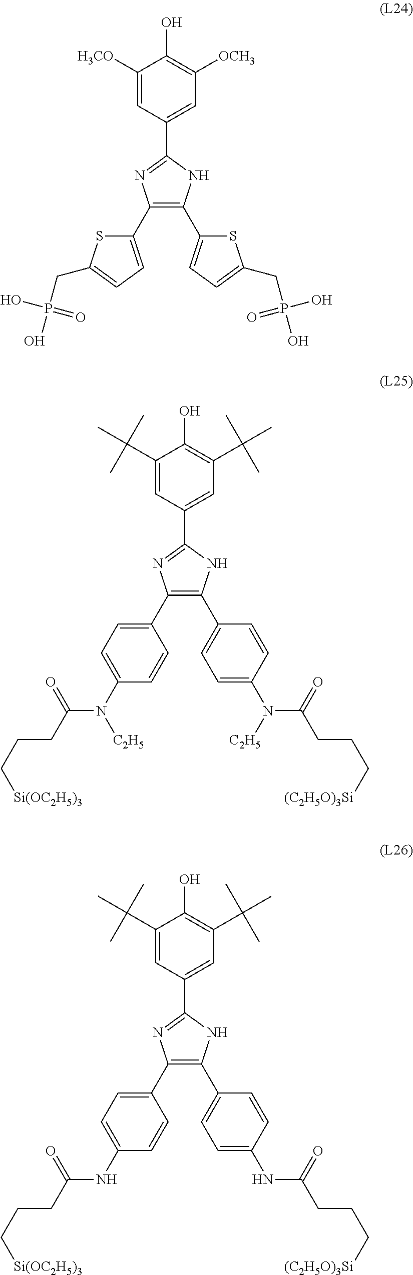

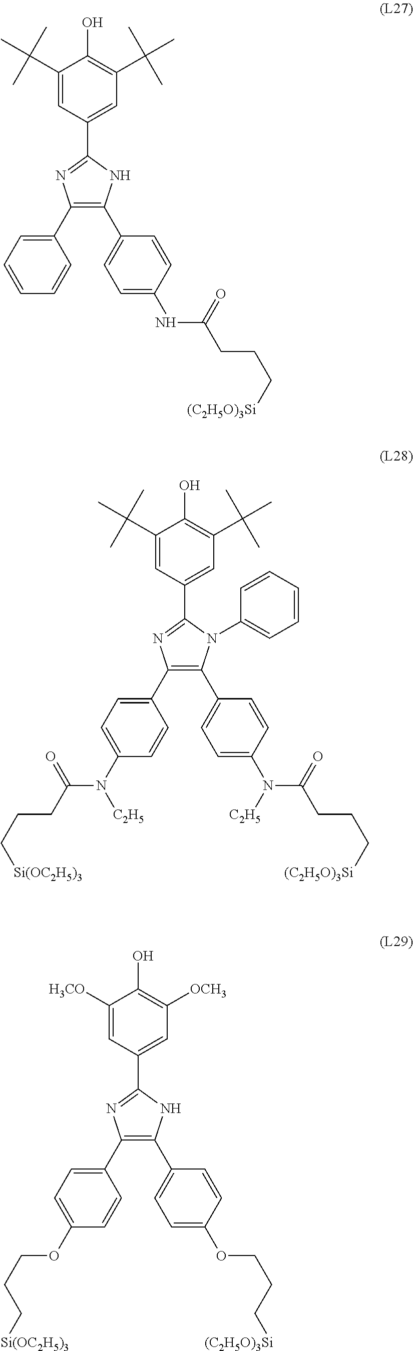

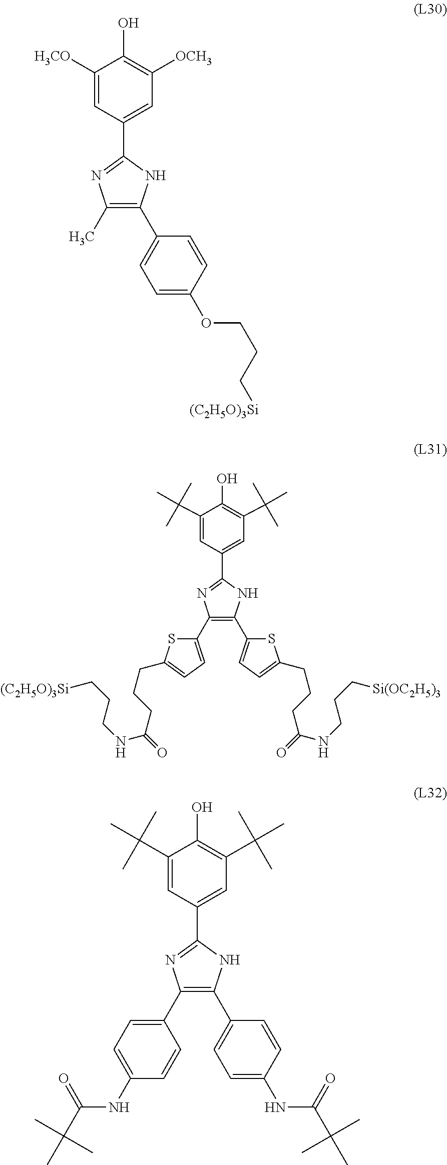

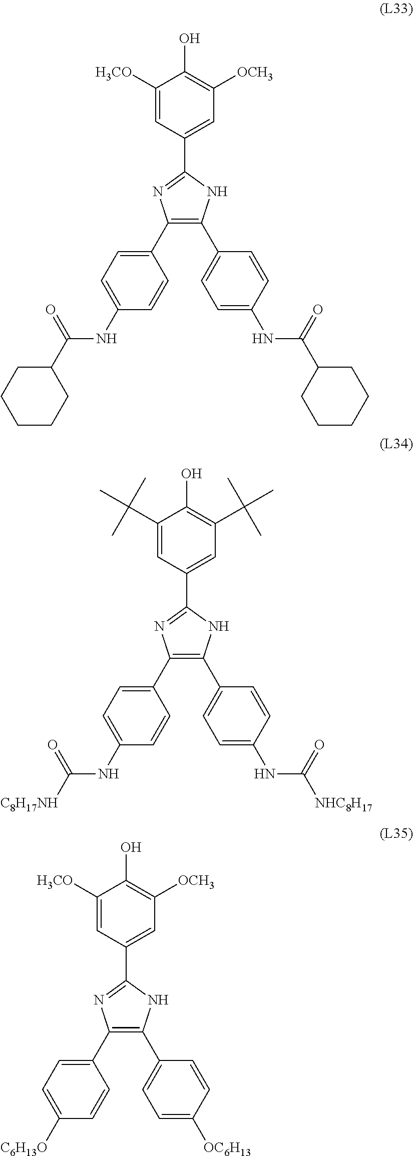

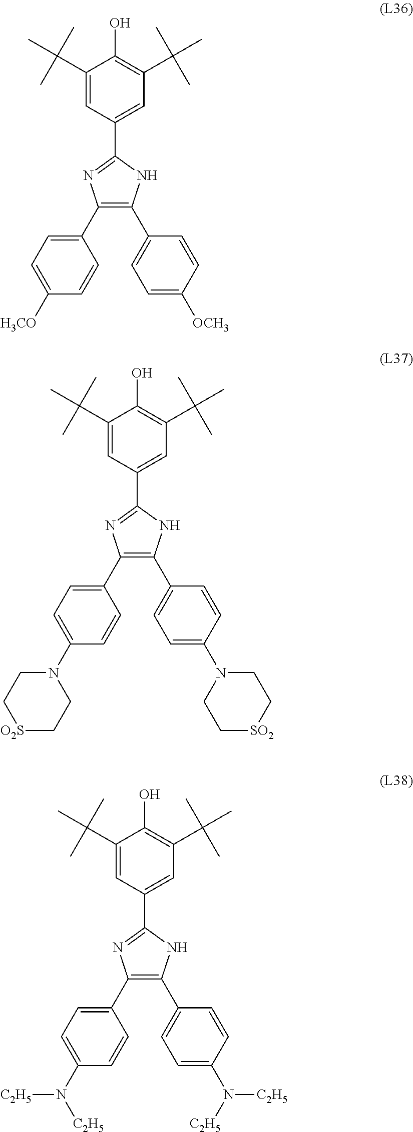

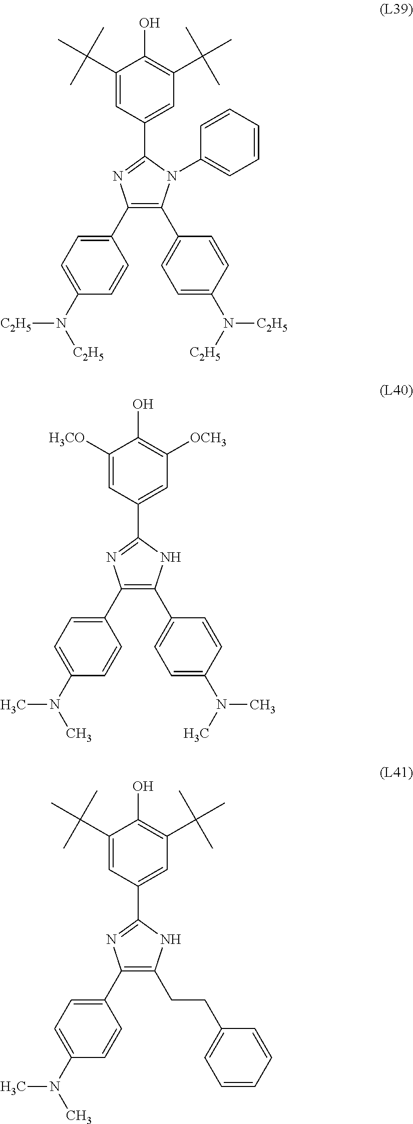

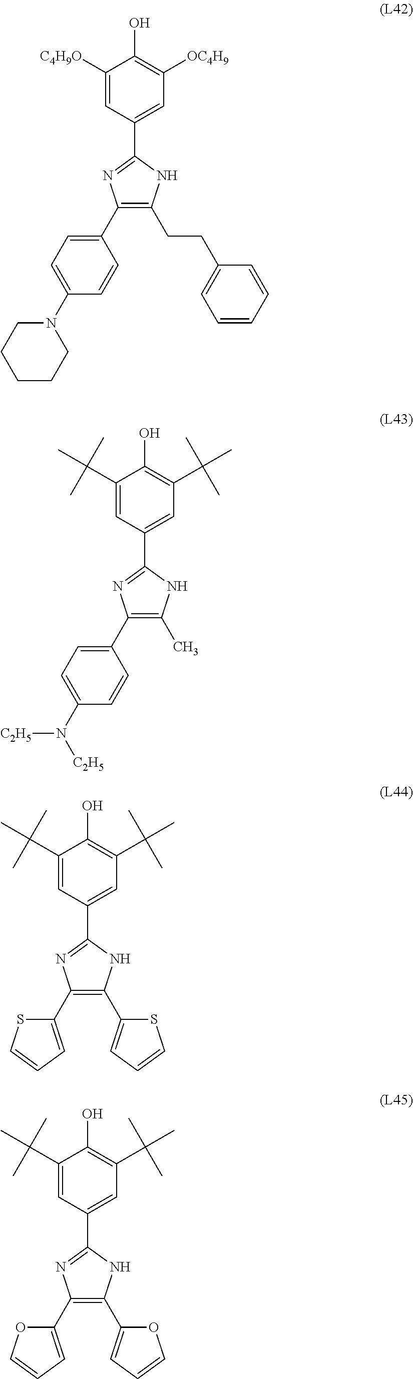

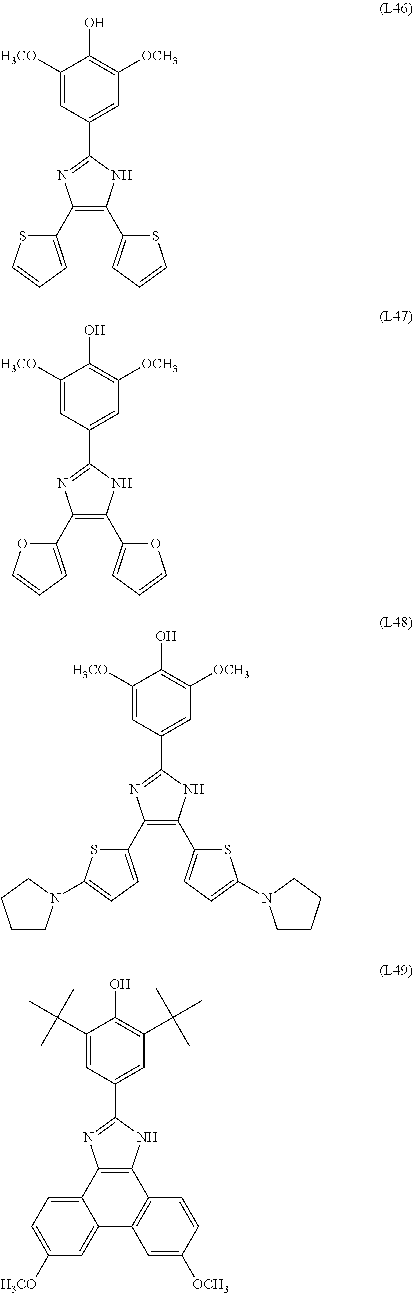

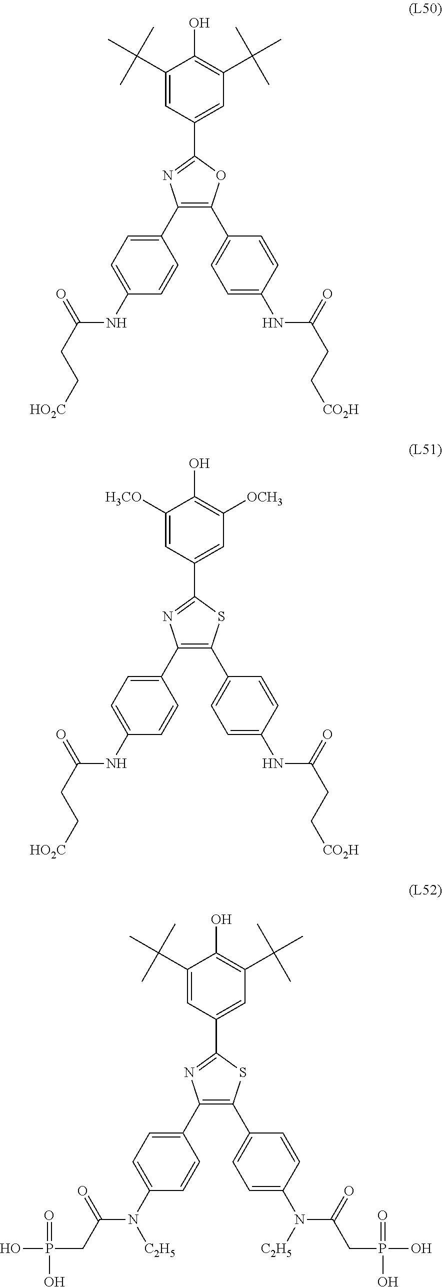

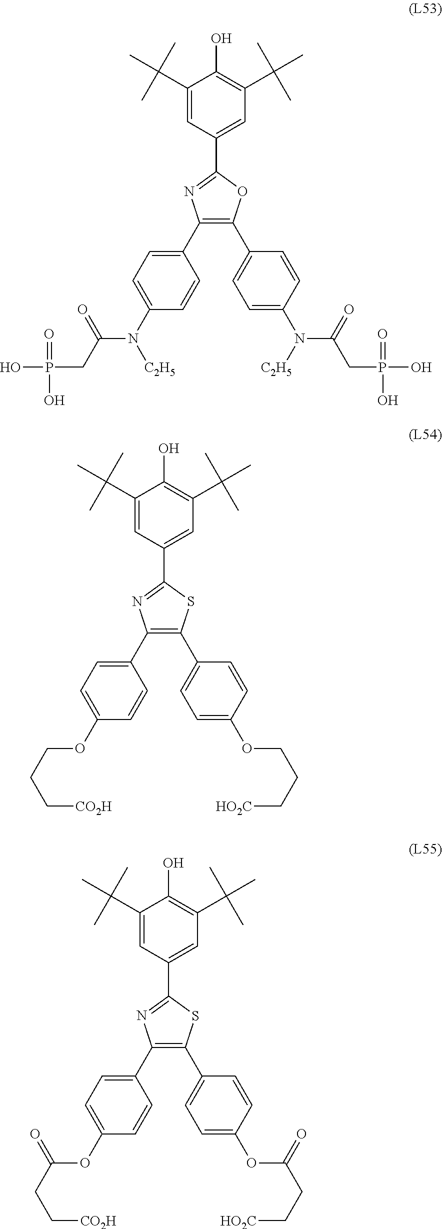

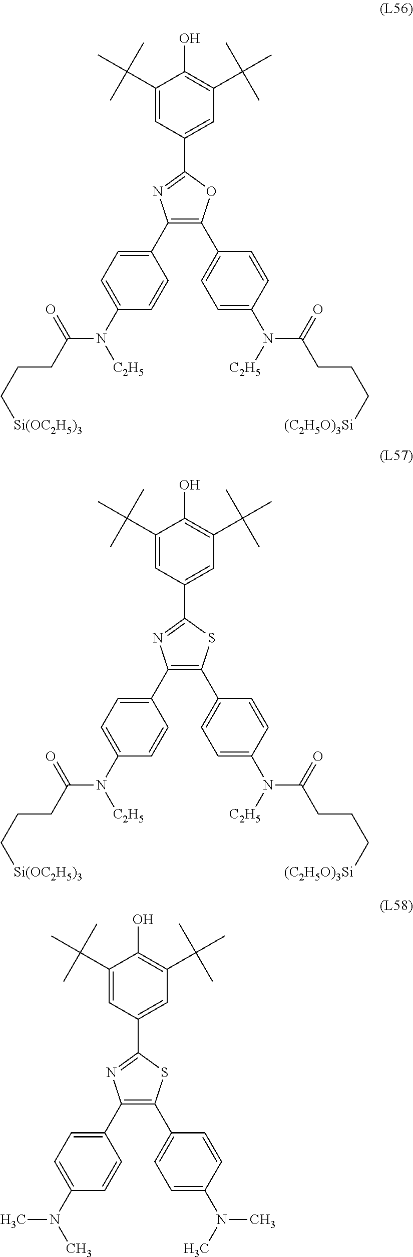

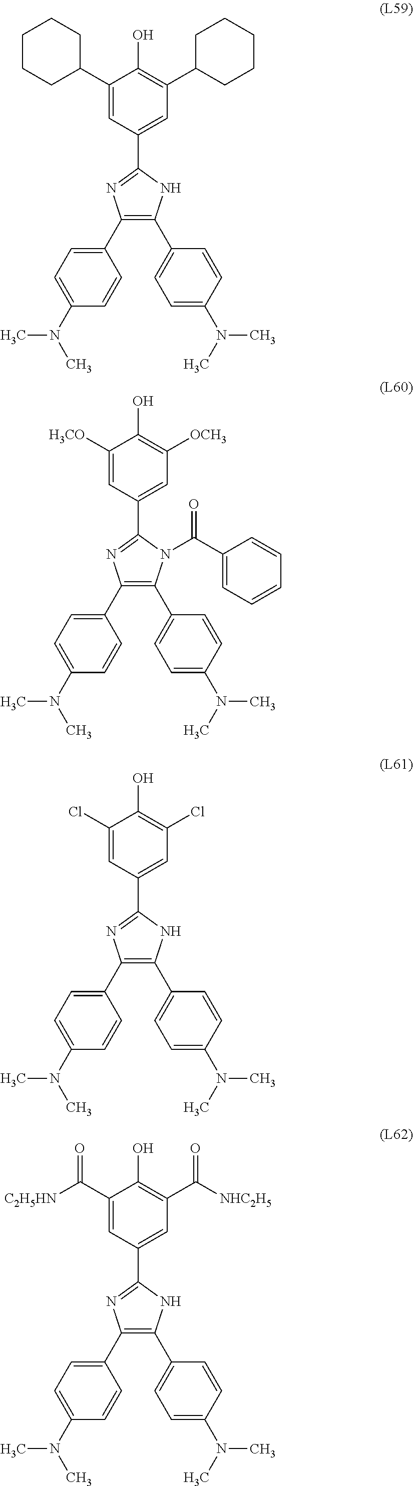

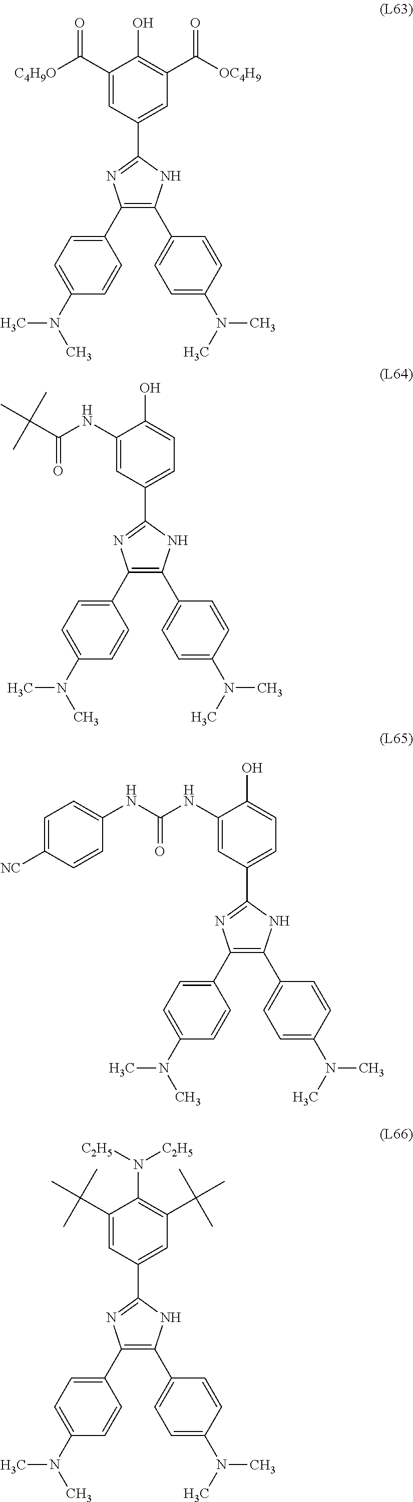

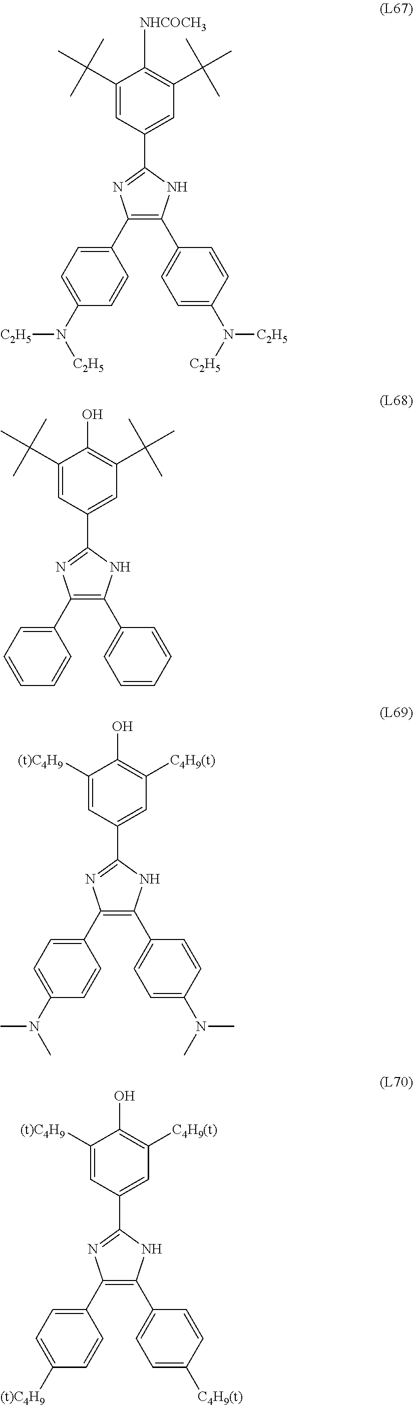

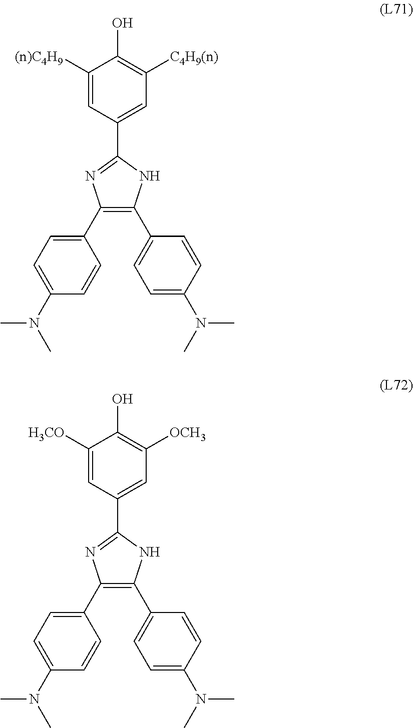

[Auxiliary Compound which can be Oxidized or Reduced]

As to a display element of the present invention, an auxiliary compound (hereinafter, referred to as a promoter) is preferably added in order to promote electrochemical reaction of a compound capable of reversibly changing color via electrochemical redox reaction. The promoter may be one whose optical density in the visible range (400-700 nm) is not changed as the result of a redox reaction, or may be one whose optical density is changed in the visible range, namely, a compound capable of reversibly changing color via an electrochemical redox reaction. Further, the promoter may be immobilized on the electrode, or may be added into an electrolytic solution. It appears that the promoter, for example, is utilized as an antipole reactant, or as a redox mediator.

For example, in a case when a compound capable of reversibly changing color via an electrochemical redox reaction to produce a color on the display electrode side via oxidization (or reduction), a high color-producing density can be obtained at a low driving voltage by using a reducing (or oxidizing) reaction of the promoter on the facing electrode side. In this way, when a promoter is utilized for an antipole reactant, it is preferred that the promoter exhibits redox activation reverse to the redox activation of a compound capable of reversibly changing color via an electrochemical redox reaction is immobilized on the facing electrode to be used. When the promoter is used as an antipole material, the promoter is preferably one of which optical density is not changed in the visible range of 400-700 nm, based on the result of redox reaction. However, as described in preferred embodiments of the present invention, in the case of an embodiment in which color produced by the promoter is blocked by employing a white scattering material in the display element, the promoter whose optical density changes at a visible range of 400-700 nm, that is, a compound which reversibly changies color via an electrochemical redox reaction may be used. An embodiment with such a structure is preferable since a promoter is easily selected. Further, it is another preferred embodiment that a promoter exhibiting the same color production as that of a compound capable of reversibly changing color via electrochemical redox reaction on the display electrode side is used.

On the other hand, a redox mediator is a material commonly used in the field of organic electrolysis synthesis. Each organic compound has an oxidization voltage depending on an electrolysis method and electrolysis conditions in addition to specific oxidation potential, and oxidation reaction is practically produced when the anode potential is higher than the oxidation potential accompanied with the above-described conditions. Since the anode potential has the experimental limit, it is impossible to entirely oxidize a substrate by a direct method. When oxidizing a substrate having high oxidizing potential, no electron is moved from the substrate to an anode. When this reaction system coexists with such a mediator that electron movement to the anode (oxidization) is produced at low potential, the mediator is first oxidized, and the substrate is oxidized by the oxidized mediator to obtain a product. The advantage of this reaction system is that it is possible to oxidize the substrate at anode potential lower than oxidization potential of the substrate, and the oxidized mediator theoretically acts as a catalyst since it moves back to the original mediator by oxidizing the substrate. Further, since oxidization at low potential becomes possible, decomposition of the substrate and the product can be inhibited.

In the present invention, for example, when used is a compound capable of reversibly changing color via electrochemical redox reactor, which produces color via oxidization as the foregoing substrate, it becomes possible to drive a display element at low driving voltage by coexisting with the oxidization mediator as catalyst quantity, and durability of the display element is increased. Further, it is advantageous that display-replacing speed is increased, and high color-producing efficiency is obtained. Similarly, the above-described effect can be produced by using a reduction mediator and a compound capable of reversibly changing color via electrochemical redox reaction, which produces color via reduction, in combination.

In the display element of the present invention, as shown in the field of organic electrolysis synthesis, a single mediator may be used, or a plurality of mediators are used in combination. When the promoter is iused as a mediator in the present invention, a compound capable of reversibly changing color via electrochemical redox reaction is immobilized on the display electrode, the promoter is preferably localized in the vicinity of the material to use it.

In the present invention, the promoter may be used as an antipole reactant, or it is also used as a mediator. For the purpose of both of them, a plurality of promoters may be simultaneously used in combination.

Promoters are not specifically limited, and can be appropriately selected based on the intended purpose. When it is utilized as an antipole reactant, a compound capable of reversibly changing color via electrochemical redox reaction is possible to be employed. Further, when it is used as a redox mediator, commonly known mediators described in Yuki Gosei Kagaku Kyokaishi (Journal of Synthetic Organic Chemistry, Japan), Vol. 43, No. 6 (“Denki Enerugi Wo Riyosuru Yuki Gosei” Tokushu-go (Special Issue “Organic Synthesis Utilizing Electrical Energy”)) (1985) can appropriately be selected and used, based on properties of the compound capable of reversibly changing color via electrochemical redox reaction.

Preferable promoters usable for the present invention include, for example, the following compounds.

1) Compounds having an N—O bond, represented by TEMPO (2,2,6,6-tetramethylpiperidinyl-N-oxyl) such as N-oxyl derivatives, N-hydroxyphthalimide derivatives, or hydroxamic acid derivatives

2) Compounds having an allyloxy free radical in which a bulky substituent is introduced into the o-position such as a galvinoxyl free radical

3) Metallocene derivatives such as ferrocene

4) Benzyl (diphenylethanedione) derivatives

5) Tetrazolium salts/formazan derivatives

6) Azine compounds such as phenazine, phenothiazine, phenoxazine, or acridine

7) Pyridinium compounds such as viologen

In addition, as a promoter, usable are benzoquinone derivatives, hydrazyl free radical compounds such as verdazyl, thiazyl free radical compounds, hydrazone derivatives, phenylenediamine derivatives, triallylamine derivatives, tetrathiafulvalene derivatives, tetracyanoquinodimethane derivatives, or thianthrene derivatives.

In the display element of the present intention, the promoters in the categories of from 1) to 7) described above are preferable, but those in 1) are specifically preferable.

Next, compounds in the category of 1) will be described in detail.

N-oxyl (referred to also as nitroxide radical) means an oxygen-centered radical generated by radically cleaving oxygen-hydrogen bond of hydroxylamine. It is known that the nitroxide radical has two reversible redox pairs as shown in the following scheme. The nitroxide radical becomes an oxoammonium cation via one-electron oxidization, which is reduced to reproduce a radical. Further, the nitroxide radical becomes an aminooxy anion via one-electron reduction, which is oxidized to produce a radical. Accordingly, the nitroxide radical can serve as a p type antipole reactant or an n type antipole reactant. Further, since the oxoammonium cation exhibits high acidity, and is capable of oxidizing a leuco dye, it serves as a mediator.

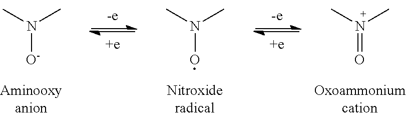

An N-oxyl derivative may be contained in an electrolyte solution, or may be immobilized on the surface of an electrode. Examples of the method of immobilizing it on the surface of an electrode include a method of introducing a group chemically or physically adsorbed onto the surface of an electrode into the N-oxyl derivative, and a method of fonning a thin film on the surface of an electrode via polymerization of the N-oxyl derivative, and so forth. In addition, the N-oxyl derivative may be added in a state of an N-oxyl radical, or may be added in a state of an N-hydroxy compound, and may further be added in a state of an oxoammonium cation.

As the N-oxyl derivative, not only TEMPO (2,2,6,6-tetramethylpiperidinyl-N-oxyl), but also a derivative in which each of various substituents is substituted is commercially available. Further, in accordance with commonly known literatures, various derivatives including polymers can be easily synthesized.

Generally, when α-carbon of the nitroxide radical is substituted by hydrogen, it is known that it has been easily disproportionated to hydroxyamine and nitrone. For this reason, four merthyl groups at theα-position of the N-oxyl group in TEMPO relate to an indispensable structure existing as a stable radical, but in contrast, reactivity may often drop because of steric hindrance of these four methyl groups.

An azaadamantane N-oxyl derivative or an azabicyclo N-oxyl derivative is preferable in view of no generation of activation drop thereof.

Next, an N-hydroxyphthalimide derivative, a hydroxamic acid derivative and so forth will be described. As shown in the following scheme, phthalimide N-oxyl (PINO) produced via electrode oxidization of N-hydrophthalimide (NHPI) oxidizes secondary alcohol to produce ketone. That is, it is reported that NHOI serves as an oxidization mediator (Chem. Commun., 1983, 479). As is clear from this example, it is to be understood that an oxidization-reduction pair of NHPI/PINO serves as an antipole reactant or a mediator in the display element of the present invention. An hydroxamic acid derivative and trihydroxyiminocyanuric acid (THICA) similarly to NHPI are also usable as a promoter.

When the display element of the present invention is prepared employing these compounds, adding is preferably carried out in a state of N—OH. After preparing a display element in a state of N—OH, a radical is produced via oxidization by driving the display element.

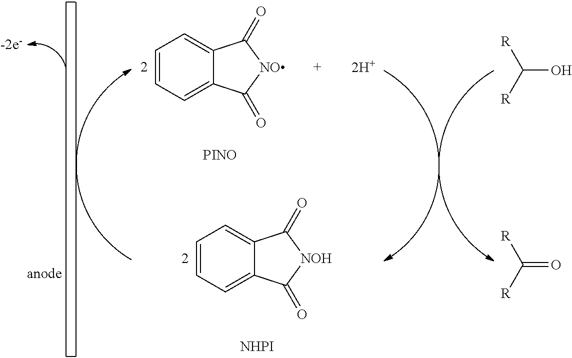

A promoter shown in the category of the above-described 1) can be represented by the following Formula (M1), and promoters represented by the following Formulae (M2)-(M6) are preferable. A polycyclic N-oxyl derivative represented by Formula (M6) is specifically preferable. In addition, each kind of promoters represented by Formulae (M1)-(M5) is commercially available, and is easily acquired. Further, in accordance with commonly known literatures, each kind of derivatives can be easily synthesized. A promoter represented by Formulae (M6) can be synthesized referrin to J. Am. Chem. Soc., 128, 8412 2006) and Tetrahedron Letters 49 (2008) 48 -52.

Promoters to polymerize these can be synthesized by referring to JP-A Nos. 2004-227946,. 2004-228008, 2006-73240, 2007-35375, 2007-70384, 2007-184227, and 2007-298713.

First, the compound represented by Formula (M1) will be described.

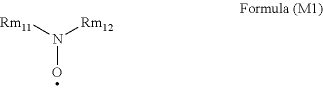

In Formula (M1) described above, each of Rm₁₁ and Rm₁₂ independently represents an aliphatic hydrocarbon group, an aromatic hydrocarbon group, a heterocyclic group, or a group connected to a nitrogen atom via >C═O, >C═S, and >C═N—Rm₁₃, which may have a substituent. Rm₁₃ represents a hydrogen atom, or an aliphatic hydrocarbon group, an aromatic hydrocarbon group or a heterocyclic group which may have a substituent. Further, Rm₁₁ and Rm₁₂ may be connected to each other to form a cyclic structure.

The aliphatic hydrocarbon group includes a chained one and a cyclic one, and the chained one includes a straight-chained one and a branched one. Examples of such an aliphatic hydrocarbon group include a methyl group, an ethyl group, a vinyl group, a propyl group, an isopropyl group, a propenyl group, a butyl group, an isobutyl group, a tert-butyl group, a pentyl group, an isopentyl group, a neopentyl group, a hexyl group, an iso-hexyl group, a cyclohexyl group, a cyclohexenyl group, an octyl group, an iso-octyl group, a cyclooctyl group, and a 2,3-dimethyl-2butyl group.

Examples of the aromatic hydrocarbon include a phenyl group and a naphthyl group. Examples of the heterocyclic group include a pyridyl group, thiazolyl group, an oxazolyl group, an imidazolyl group, a furyl group, a pyrrolyl group, a pyrazinyl group, a pyrimidinyl group, a pyridazinyl group, a selenazolyl group, a sulforanyl group, a piperidinyl group, a pyrazolyl group, a tetrazolyl group, and a morpholino group.

These substituents may further have a substituent. The substituent is not specifically limited, and examples thereof include an alkyl group (for example, a methyl group, an ethyl group, a propyl group, an isopropyl group, a tert-butyl group, a pentyl group, a hexyl group, an octyl group, a dodecyl group, a tridecyl group, a tetradecyl group, a pentadecyl group, or the like), a cycloalkyl group (for example, a cyclopropyl group, a cyclopentyl goup, a cyclohexyl group, or the like), an alkenyl group (for example, a vinyl group, an allyl group, a butenyl group, an octenyl group, or like), a cyclo alkenyl group (for example, a 2-cyclopentene-1-yl group, a 2-cyclohexene-1-yl group, or the like) an alkynyl group (for example, a propargyl group, an ethynyl group, a trimethylsilylethynyl group, or the like), an aryl group (for example, a phenyl group, a naphthyl group, a p-tolyl group, an m-chlorophenyl group, an o-hexadecanoylaminophenyl group, or the like), a heterocycle group (for example, a pyridyl group, a thiazolyl group, an oxazolyl group, an imidazolyl group, a furil group, a pyrrolyl group, a pyrazinyl group, a pyrimidinyl group, a pyridazinyl group, a selenazolyl group, a sulforanyl group, a piperidinyl group, a pyrazolyl group, a tetrazolyl group, a morpholino group, or the like), a heterocyclicoxy group (for example, a 1-phenyltetrazole-5-oxy group, a 2-tetrahydropyranyloxy group, a pyridyloxy group, a thiazolyloxy group, an oxazolyloxy group, an imidazolyloxy group, or the like), a halogen atom (for example, a chlorine atom, a bromine atom, iodine atoms, a fluorine atom, or the like), an alkoxy group (for example, a methoxy group, an ethoxy group, a propyloxy group, a tert-butoxy group, a pentyloxy group, a hexyloxy group, an octyloxy group, a dodecyloxy group, or the like), a cycloalkoxy group (for example, a cyclopentyloxy group, a cyclohexyloxy group, or the like), an aryl oxygroup (for example, a phenoxy group, a 2-naphthyloxy group, a 2-methylphenoxy group, a 4-tert-butylphenoxy group, a 3-nitrophenoxy group, a 2-tetradecanoylaminophenoxy group, or the like), an alkylthio group (for example, a methylthio group, an ethylthio group, a propylthio group, a pentylthio group, a hexylthio group, an octylthio group, a dodecylthio group, or the like), a cycloalkylthio group (for example, a cyclopentylthio group, a cyclohexylthio group, or the like), an arylthio group (for example, a phenylthio group, a 1-naphthylthio group, or the like), a heterocyclic thio group (for example, a pyridylthio group, a thiazolylthio group, an oxazolylthio group, an imidazolylthio group, a furilthio group, a pyrrolylthio group, or the like), an alkoxycarbonyl group (for example, a methoxycarbonyl group, an ethoxycarbonyl group, a butoxycarbonyl group, an octyloxycarbonyl group, a dodecyloxycarbonyl group, or the like), an aryloxycarbonyl group (for example, a phenyloxycarbonyl group, a naphthyloxycarbonyl group, or the like), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, a 2-pyridylaminosulfonyl group, a morpholinosulfonyl group, a pyrrolidinosulfonyl group, or the like), a ureido group (for example, a methylureido group, an ethylureido group, a pentylureido group, a cyclohexylureido group, an octylureido group, a dodecylureido group, a phenylureido group, a naphthylureido group, a 2-pyridylaminoureido group, or the like), an acyl group (for example, an acetyl group, an ethylcarbonyl group, and a propylcarbonyl group, a pentylcarbonyl group, a cyclohexylcarbonyl group, an octylcarbonyl group, a 2-ethylhexylcarbonyl group, a dedecylcarbonyl group, a phenylcarbonyl group, a naphthylcarbonyl group, a pyridylcarbonyl group, or the like), an acyloxy group (for example, a formyloxy group, an acetyloxygroup, a pivaloyl oxy group, a stearoyloxy group, a benzoyloxy group, a p-methoxyphenylcarbonyloxy group, an ethylcarbonyloxy group, a butylcarbonyloxy group, an octylcarbonyloxy group, a dodecylcarbonyloxy group, a phenylcarbonyloxy group, or the like), an acylamino group (for example, an acetylamino group, a benzoylamino group, a formylamino group, a pivaloylamino group, a lauroylamino group, a 3,4,5-tri-n-octyloxyphenylcarbonylamino group, or the like), a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group, a 2-pyridylaminocarbonyl group, a morpholinocarbonyl group, a piperazinocarbonyl group, or the like), an alkanesulfinyl group or an arylsulfinyl group (for example, a methanesultinyl group, an ethanesulfmyl group, a butanesulfonyl group, a cyclohexanesulfmyl group, a 2-ethylhexanesulfinyl group, a dodecanesulfmyl group, a phenylsulfonyl group, a naphthylsulfinyl group, a 2-pyridylsulfmyl group, or the like), an alkanesulfonyl group or an arylsulfonyl group (for example, a methanesulfonyl group, an ethanesulfonyl group, a butanesulfonyl group, a cyclohexanesulfonyl group, a 2-ethylhexanesulfonyl group, a dodecanesulfonyl group, a phenylsulfonyl group, a naphthylsulfonyl group, a 2-pyridyl sulfonyl group, or the like), an amino group (for example, an amino group, a methylamino group, an ethylamino group, a dimethylamino group, a butylamino group, a cyclopentylamino group, a 2-ethylhexylamino group, a dodecylamino group, an anilino group, an N-methylanilino group, a diphenylamino group, a naphthylamino group, a 2-pyridyl amino group, or the like), a silyloxy group (for example, a trimethylsilyloxy group, a tert-butyldimethylsilyloxy group, or the like), an amino carbonyloxy group (for example, an N,N-dimethylcarbamoyloxy group, an N,N-diethylcarbamoyloxy group, a morpholinocarbonyloxy group, an N,N-di-n-octylaminocarbonyloxy group, a N-n-octylcarbamoyloxy group, or the like), an alkoxycarbonyloxy group (for example, a methoxycarbonyloxy group, an ethoxycarbonyloxy group, a tert-butoxycarbonyloxy group, an n-octylcarbonyloxy group, or the like), an aryloxycarbonyloxy group (for example, a phenoxycarbonyloxy group, a p-methoxyphenoxycarbonyloxy group, a p-n-hexadecyloxyphenoxycarbonyloxy group, or the like), an alkoxyearbonylamino group (for example, a methoxycarbonylamino group, an ethoxycarbonylamino group, a tert-butoxycarbonylamino group, an n-octadecyloxycarbonylamino group, an N-methyl-methoxycarbonylamino group, or the like), an aryloxycarbonylamino group (for example, a phenoxycarbonylamino gropu, a p-chlorophenoxycarbonylamino group, an m-n-octyloxyphenoxycarbonylamino group, or the like), a sulfamoylamino group (for example, a sulfamoylamino group, an N,N-dimethylaminosulfonylamino group, an N-n-octylaminosulfonylamino group, or the like), a mercapto group, an arylazo group (for example, a phenylazo group, a naphthylazo group, a p-chlorophenylazo group, or the like), a heterocyclic azo group (for example, a pyridylazo group, a thiazolylazo group, an oxazolylazo group, an imidazolylazo group, a furilazo group, a pyrrolylazo group, a 5-ethylthio-1,3,4-thiadiazole-2-ylazo group, or the like), an imino group (for example, an an N-succinimide-1-yl group, an N-phthalimide-1-yl group, or the like), a phosphino group (for example, a dimethylphosphino group, a diphenylphosphino group, a methylphenoxyphosphino group, or the like), a phosphinyl group (for example, a phosphinyl group, a dioctyloxyphosphinyl group, a diethoxyphosphinyl group, or the like), a phosphinyloxy group (for example, a diphenoxyphosphinyloxy group, a dioctyloxyphosphinyloxy group, or the like), a phosphinylamino group (for example, a dimethoxyphosphinylamino group, a dimethylaminophosphinylamino group, or the like), a silyl group (for example, a trimethylsilyl group, a tert-butyldimethylsilyl group, a phenyldimethylsilyl group, or the like), a cyano group, a nitro group, a hydroxyl group, a sulfo group, a carboxyl group, and so forth.

The compound represented by Formula (M1) may be a multimer such as a dimmer, a trimer or the like connected by the foregoing substituent, or may also be a polymer.

Next, the compound represented by Formula (M2) will be described.

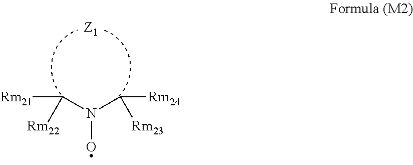

In Formula (M2) described above, each of Rm₂₁, Rm₂₂, Rm₂₃ and Rm₂₄ independently represents an aliphatic hydrocarbon group, an aromatic hydrocarbon group or a heterocyclic group which may have a hydrogen atom or a substituent. These aliphatic hydrocarbon group, aromatic hydrocarbon group and heterocyclic group are synonymous with those shown in foregoing Formula (M1).

Z₁ represents a group of atoms to form a cyclic structure, and preferably forms a 5-membered ring or a 6-membered ring. Z₁ may further have a substituent, and as a substituent thereof, provided is the same substituent as represented by foregoing Formula (M1). Atoms constituting Rm₂₁-Rm₂₄ and Z₁ may be connected to each other to form a cyclic structure, and for example, a polycyclic structure together with nitrogen atoms such as an a zanorbornene structure, an azaadamantane structure or the like may be formed.

As a cyclic structure of the compound represented by Formula (M2), preferable is a piperidine ring, a pyrrolidine ring or an azaadamantane ring.

Next, the compound represented by Formula (M3) will be described.

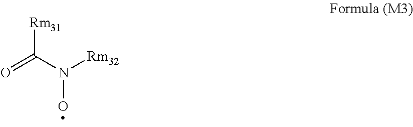

In the present invention, as one of the preferred embodiments, the N-oxyl derivative according to the present invention is a compound represented by Formula (M3).

In Formula (M3) described above, Rm₃₁ represents an aliphatic hydrocarbon group, an aromatic hydrocarbon group or a heterocyclic group, which may a substituent substituted by a carbonyl carbon atom directly or via an oxygen atom, a nitrogen atom and a sulfur atom. Rm₃₂ represents an aliphatic hydrocarbon group, an aromatic hydrocarbon group or a heterocyclic group which may have a substituent. These aliphatic hydrocarbon group, aromatic hydrocarbon group and heterocyclic group are synonymous with those shown in foregoing Formula (M1). Rm₃₁ and Rm₃₂ may be connected to each other to form a cyclic structure.

In Formula (M3), Rm₃₂ is preferably an aromatic hydrocarbon group, but a phenyl group which may have a substituent is specifically preferable. As a substituent in the phenyl group, preferable is an electron withdrawing group such as a cyano group, an alkoxycarbonyl group, a trifluoromethyl group or the like. As Rm₃₁, preferable is a phenyl group or an aliphatic hydrocarbon group directly connected to a carbonyl carbon atom, and a branched alkyl group and a cycloalkyl group are specifically preferable. In addition, the compound represented by Formula (M3) is preferably added in a state of N-OH to form a display element.

Next, the compound represented by Formula (M4) will be described.

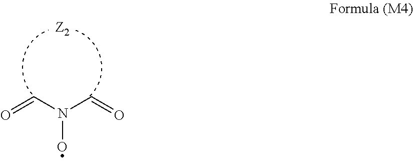

In the present invention, as one of the preferred embodiments, the N-oxyl derivative according to the present invention is a compound represented by Formula (M4).

In Formula (M4) described above, Z₂ represents a group of atoms to form a cyclic structure, and preferably forms a 5-membered ring or a 6-membered ring. Z₂ may further have a substituent, and as a substituent thereof, provided is the substituent shown in Formula (M1). Further, Z₂ may be a condensed ring. In addition, the compound represented by Formula (M4) is preferably added in a state of N—OH to form a display element.

Next, the compound represented by Formula (M5) will be described.

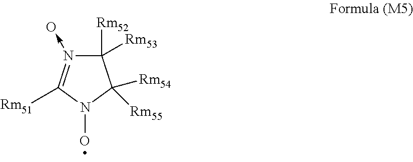

In the present invention, as one of the preferred embodiments, the N-oxyl derivative according to the present invention is a compound represented by Formula (M5).

In Formula (M5) described above, each of Rm₅₁-Rm₅₅ independently represents an aliphatic hydrocarbon group, an aromatic hydrocarbon group or a heterocyclic group which may have a substituent. These aliphatic hydrocarbon group, aromatic hydrocarbon group and heterocyclic group are synonymous with those shown in foregoing Formula (M1).

In Formula (M5), Rm₅₁ is preferably an aromatic hydrocarbon group, but a phenyl group which may have a substituent is specifically preferable. As a substituent in the phenyl group, preferable is an electron withdrawing group such as a cyano group, an alkoxycarbonyl group, a trifluoromethyl group or the like. Each of Rm₅₂-Rm₅₅ preferably an alkyl group having 1-6 carbon atoms, and arnethyl group is s ecifically preferable.

Next, the compound represented by Formula (M6) will be described.

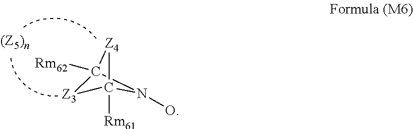

In Formula (M6) described above, Rm₆₁ and Rm₆₂ independently represents an aliphatic hydrocarbon group which may have a hydrogen atom or a substituent. Each of Rm₆₁ and Rm₆₂ is preferably a hydrogen atom or a straight-chain alkyl group having not more than 4 atoms, and at least one of Rm₆₁ and Rm₆₂ is preferably a hydrogen atom.

Each of Z₃, Z₄ and Z₅ represents a group of atoms to form a cyclic structure (for example, carbon, nitrogen, oxygen, sulfur or the like), and preferably forms a 5-membered ring or a 6-membered ring. Each of Z₃, Z₄ and Z₅ may further have a substituent.

Numeral n is 0 or 1, but when n=0, Formula (M6) represents a bicyclo compound, and when n=1, Formula (M6) represents a tricyclo compound.

As a compound represented by Formula (M6), numeral n is preferably 0, and an azaadamantane derivative is specifically preferable.

Specific examples of promoters usable in the present invention are shown below, but the present invention is not limited thereto.

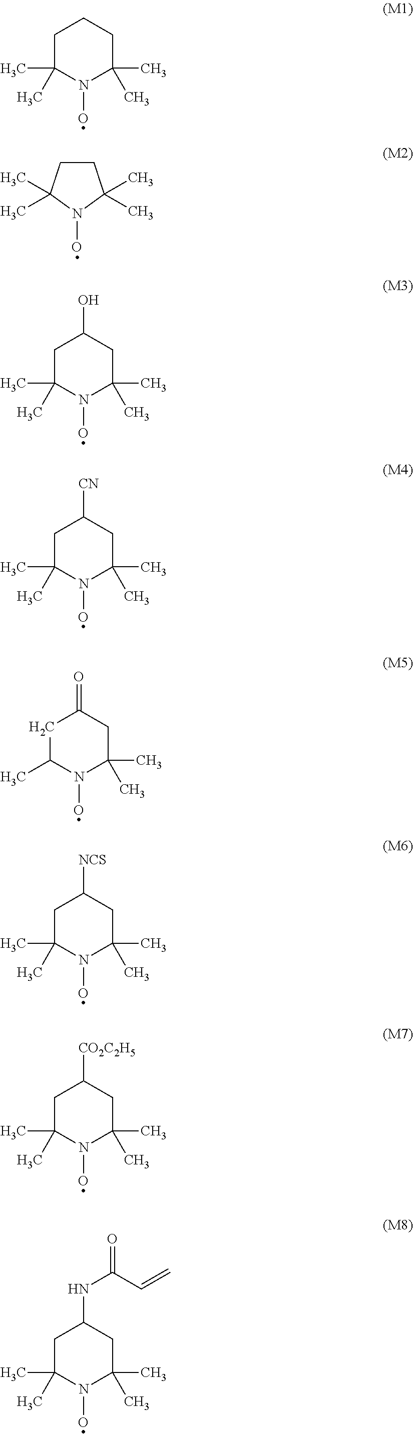

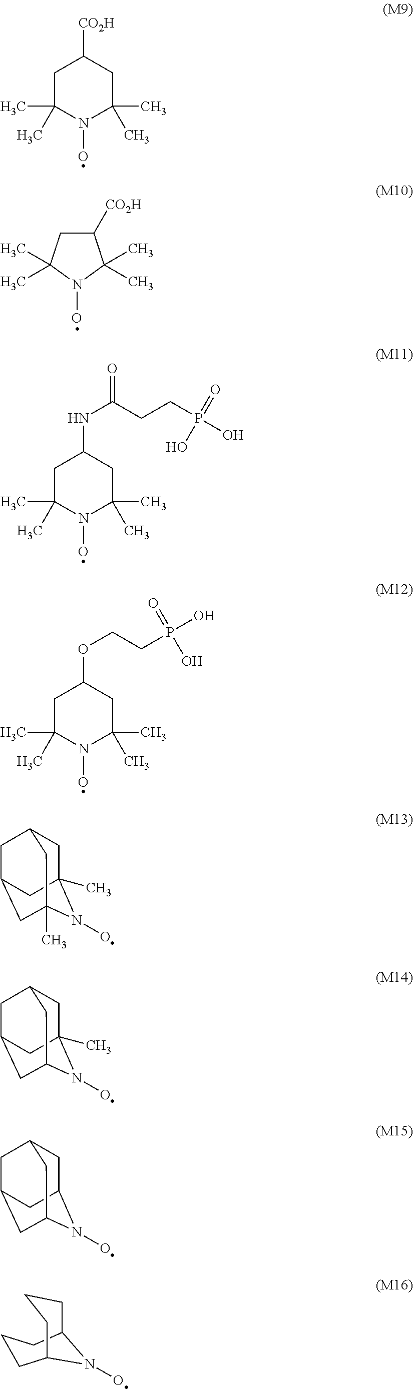

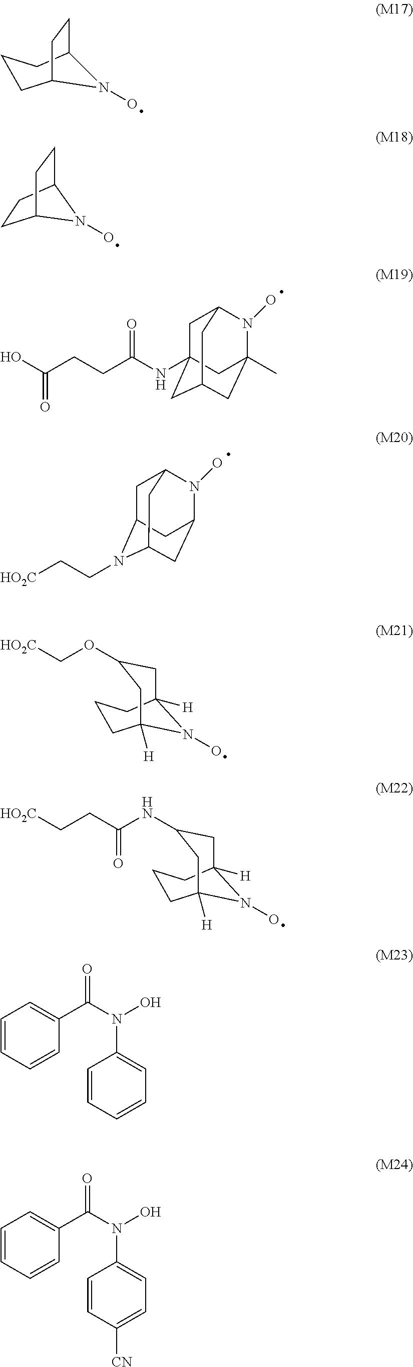

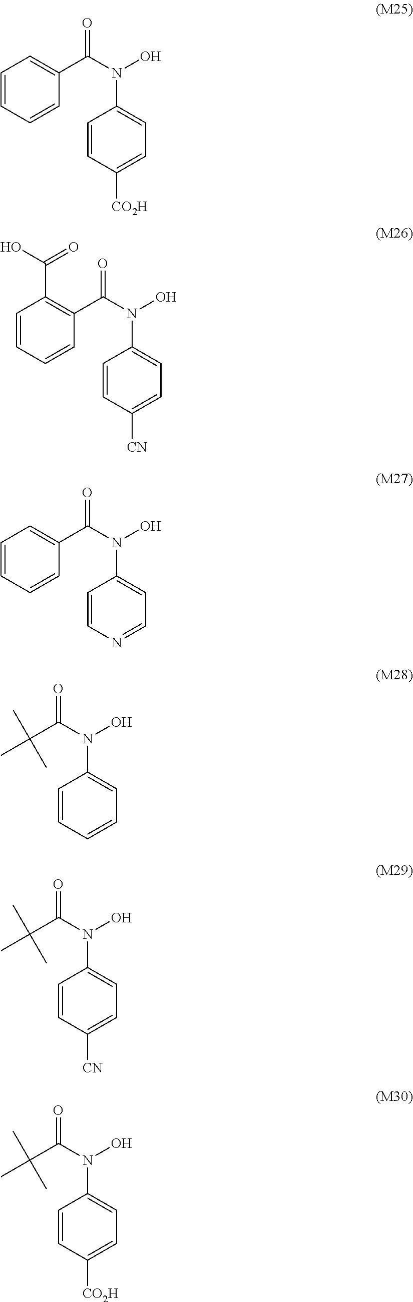

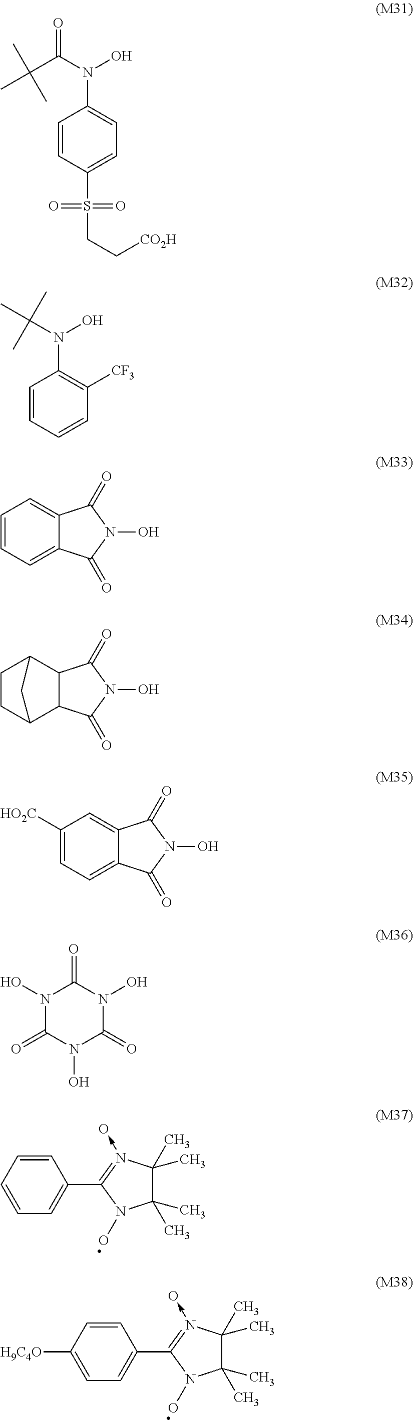

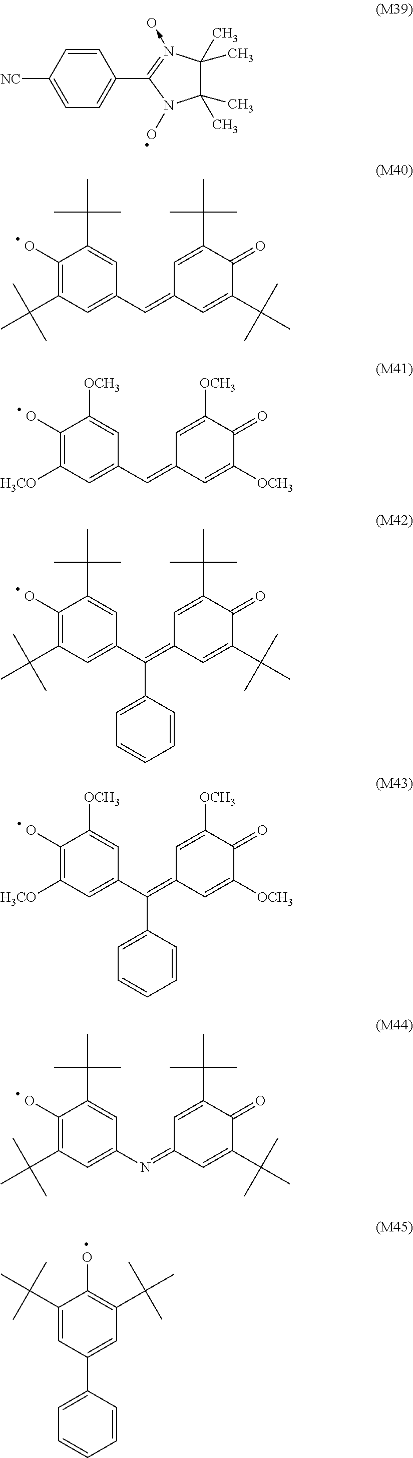

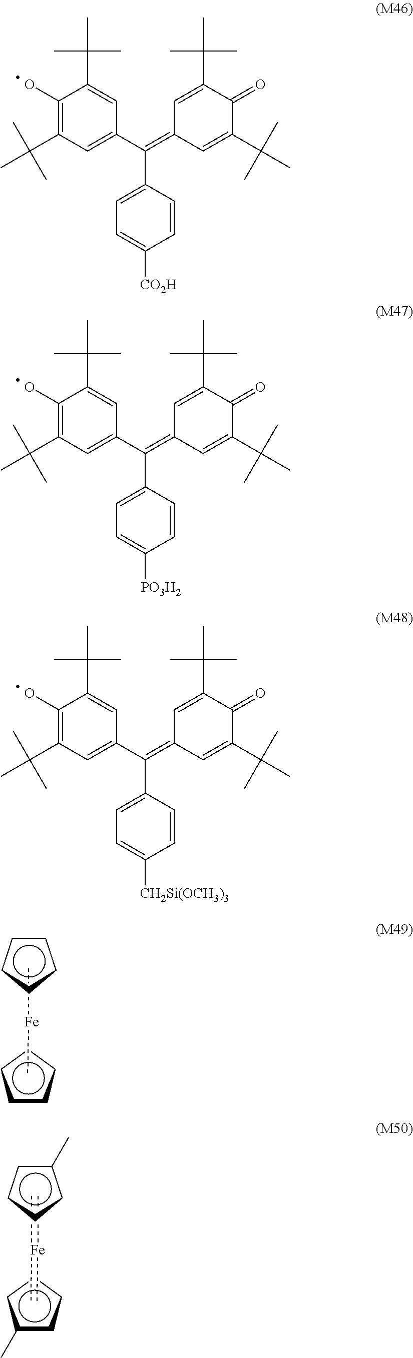

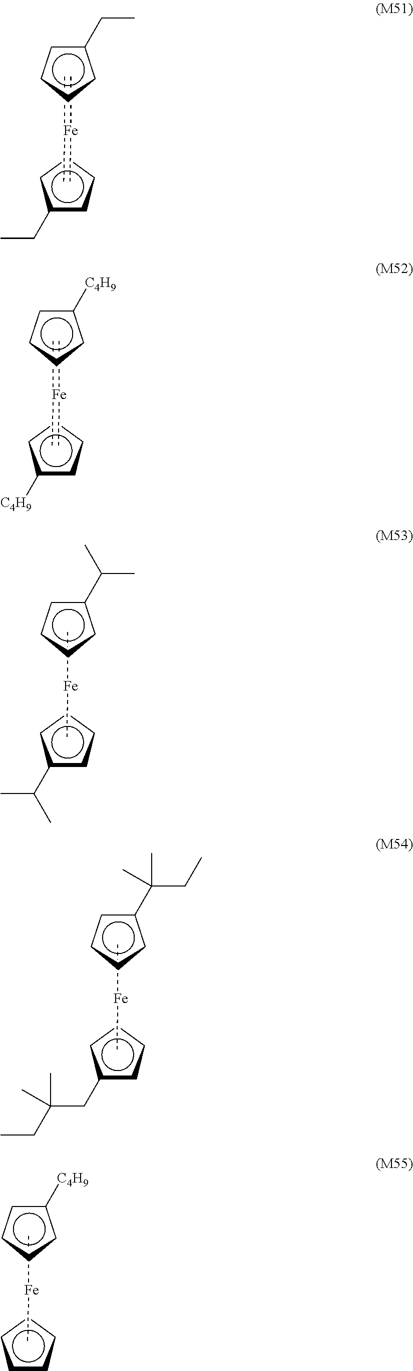

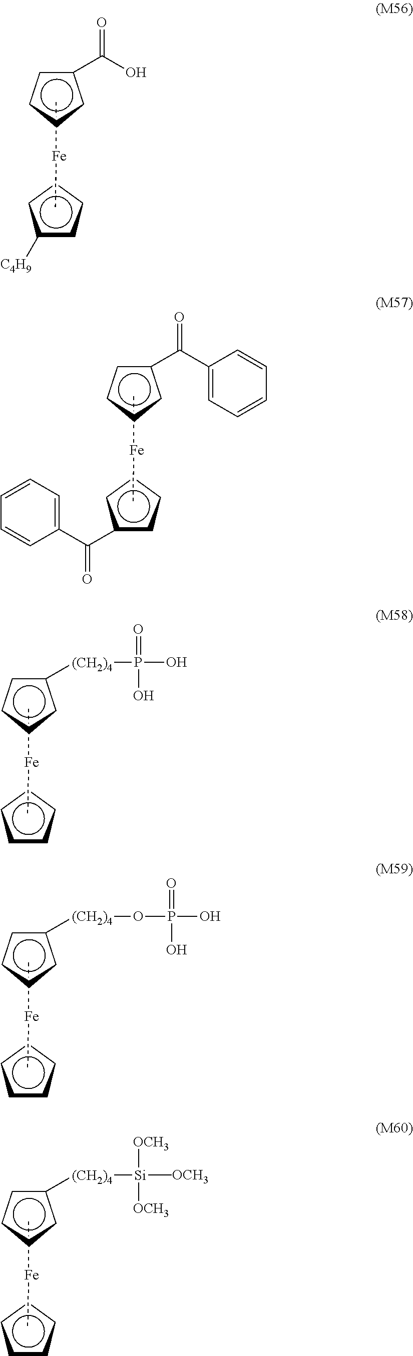

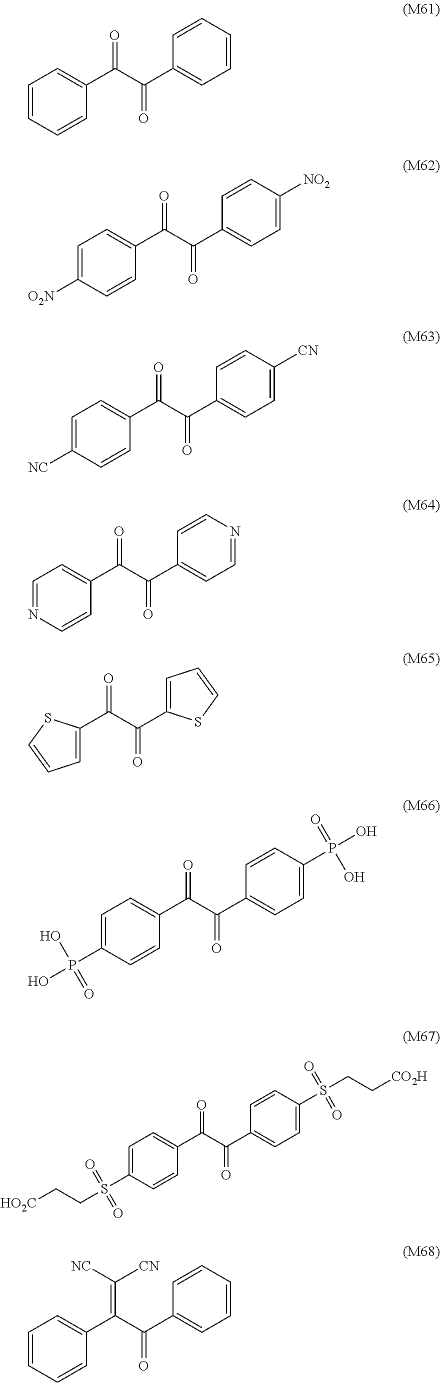

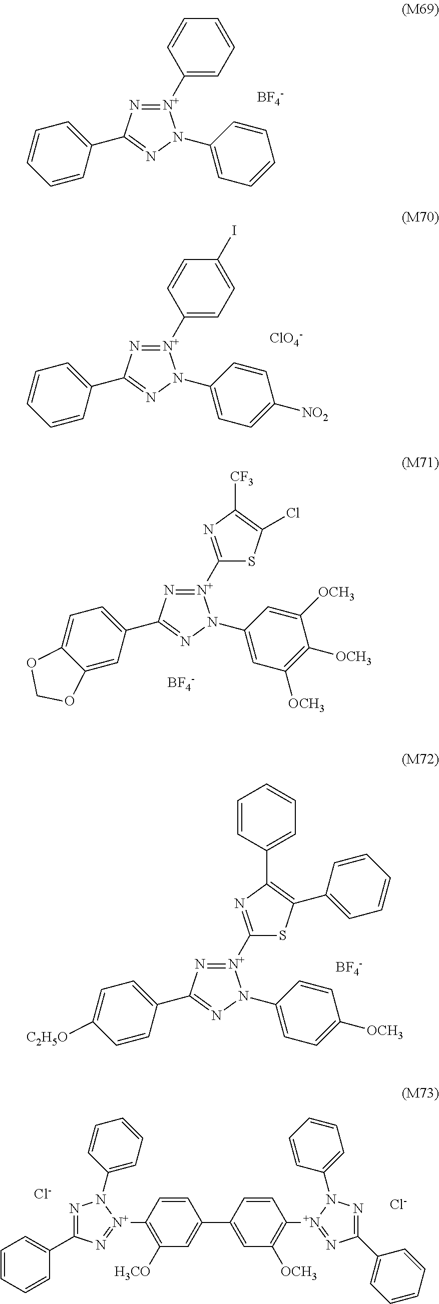

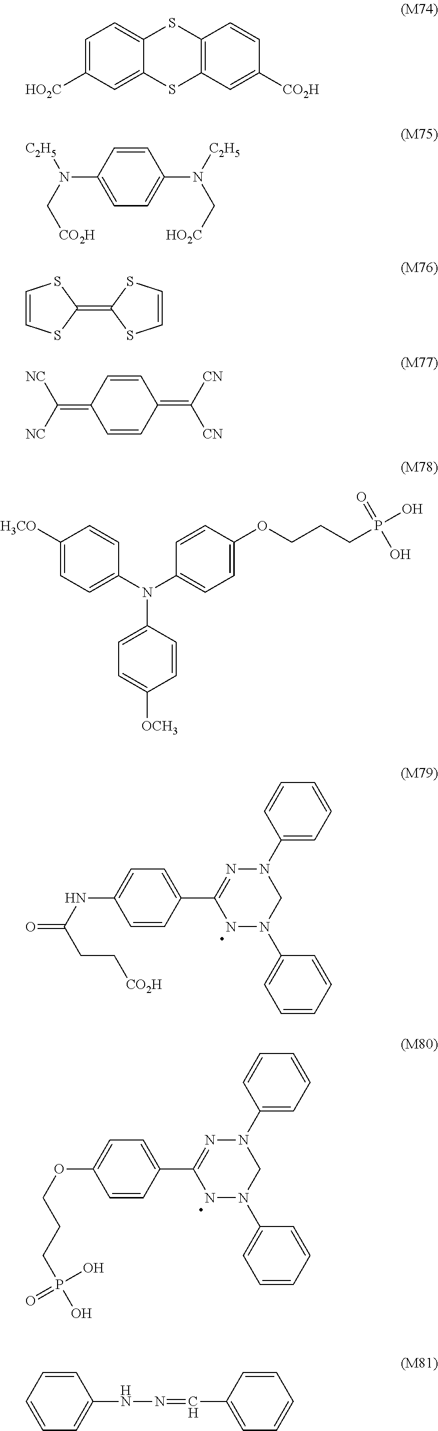

### [Organic Solvent]

In the electrolyte according to the present invention, usable is a solvent which is generally used for an electrochemical cell or for a battery and dissolves an electrochromic compound used in the present invention, a metal salt compound which is reversibly dissolved or deposited with an electrochemical redox reaction and a promoter.

Specifical examples of a solvent include acetic anhydride, methanol, ethanol, tetrahydrofuran, ethylene carbonate, ethylmethyl carbonate, diethyl carbonate, dimethyl carbonate, butylene carbonate, propylene carbonate, nitromethane, acetonitrile, acetylacetone, N-methyl formamide, N,N-dimethylformamide, dimethyl sulfoxide, hexamethyl phosphoamides, dimethoxy ethane, diethoxy furan, γ-butyrolactone, γ-valerolactone, sulfolane, propionitrile, butyronitrile, glutaronitrile, adiponitrile, methoxy acetonitrile, N-methyl acetamide, N,N-dimethylacetamide, N-methylpropione amide, methyl pyrrolidinone, 2-(N-methyl)-2-pyrrolidinone, dimethyl sulfoxide, dioxolane, trimethyl phosphate, triethyl phosphate, tripropyl phosphate, ethyldimethyl phosphate, tributyl phosphate, tripentyl phosphate, trihexyl phosphate, triheptyl phosphate, trioctyl phosphate, trinonyl phosphate, tridecyl phosphate, tris(trifluoromethyl) phosphate, tris(pentafluoroethyl) phosphate, triphenyl phosphate, tricresyl phosphate, 2-ethylhexyl phosphate, tetramethylurea, 1,3-dimethyl-2-imidazolidinone, hexamethylphosphortriamide, 4-methyl-2-pentanone, dioctyl phthalate, dioctyl sebacate, and glycols such as ethylene glycol, diethylene glycol and triethyleneglycol monobutylether.

Furthermore, a normal temperature fused salt can also be used as a solvent. The above-mentioned normal temperature fused salt is a salt only containing an ion pair without a solvent, which is melted at an ambient temperature (namely, in a liquid state). It means a salt composed of an ion pair, of which melting point is usually 20° C. or less, and it exhibits a liquid phase at a temperature exceeding 20° C. The normal temperature fused salt can be used singly or in combination of two or more kinds.

As an electrolyte solvent used for the present invention, an aprotic polar solvent is preferable. Specifically, preferable examples include propylene carbonate, ethylene carbonate, dimethyl sulfoxide, dimethoxy ethane, acetonitrile, γ-butyrolactone, sulfolane, dioxolane, dimethylformamide, dimethoxy ethane, tetrahydrofuran, adiponitrile, methoxy acetonitrile, dimethylacetamide, methyl pyrrolidinone, dimethyl sulfoxide, dioxolane, sulfolane, trimethyl phosphate, and triethyl phosphate. As a solvent, one of them may be used independently, or may be used in combination of two or more kinds.

In the present invention, a solvent specifically preferably employed contains a compound represented by Formula (S1) or Formula (S2).

### <Compounds Represented by Formulae (S1) and (S2)>

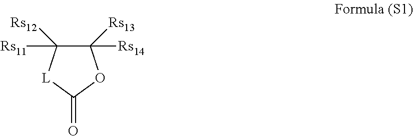

In above Formula (S1), L represents an oxygen atom or an alkylene group, and Rs₁₁-Rs₁₄ each represent a hydrogen atom, an alkyl group, an alkenyl group, an aryl group, a cycloalkyl group, an alkoxyalkyl group or an alkoxy group.

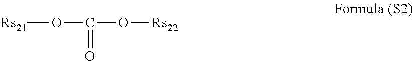

In above Formula (S2), Rs₂₁ and Rs₂₂ each represent an alkyl group, an alkenyl group, an aryl group, a cycloalkyl group, an alkoxyalkyl group or an alkoxy group.

First, the compound represented by Formula (S1) will be detailed.

In the foregoing Formula (S1), L represents an oxygen atom or CH₂, and Rs₁₁-Rs₁₄ each represent a hydrogen atom, an alkyl group, an alkenyl group, an aryl group, a cycloalkyl group, an alkoxyalkyl group or an alkoxy group. These substituents may further be substituted with any appropriate substituent.

Examples of the alkyl group include a methyl group, an ethyl group, a propyl group, an isopropyl group, a t-butyl group, a pentyl group, a hexyl group, a dodecyl group, a tridecyl group, a tetradecyl group and a pentadecyl group; examples of an aryl group include a phenyl group and a naphthyl group; examples of a cycloalkyl group include a cyclopentyl group and a cyclohexyl group; examples of a alkoxyalkyl group include a β-methoxyethyl group and a γ-methoxypropyl group; and examples of an alkoxy group include a methoxy group, an ethoxy group, a propyloxy group, a pentyloxy group, an octyloxy group and a dodecyloxy group.

Specific examples of compounds represented by Formula (S1) are shown below, but the present invention is not limited to these exemplified compounds.

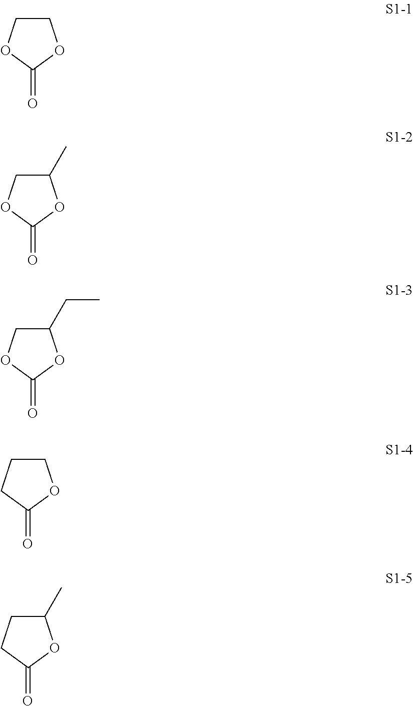

Next, the compound represented by Formula (S2) will be described in detail.

In the foregoing Formula (S2), Rs₂₁ and R s₂₂ each represent a hydrogen atom, an alkyl group, an alkenyl group, an aryl group, a cycloalkyl group, alkoxyalkyl group or an alkoxy group.

Examples of the alkyl group include a methyl group, an ethyl group, a propyl group, an isopropyl group, a t-butyl group, a pentyl group, a hexyl group, a dodecyl group, a tridecyl group, a tetradecyl group and a pentadecyl group; examples of the aryl group include a phenyl group and a napthyl group; examples of the cycloalkyl group include a cyclopentyl gropu and a cyclohexyl group; examples of a alkoxyalkyl group include a β-methoxyethyl group and a γ-methoxypropyl group; and examples of the alkoxy group include a methoxy group, an ethoxy group, a propyloxy group, a pentyloxy group, an octyloxy group and a dodecyloxy group.

Specific examples of compounds represented by Formula (S2) are shown below, but the present invention is not limited to these exemplified compounds.

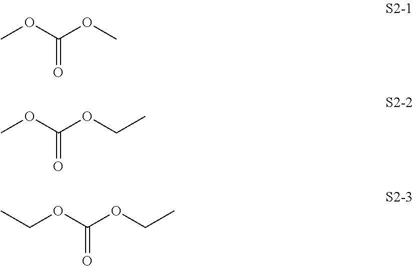

Among compounds represented by Formula (S1) and Formula (S2) as exemplified above, compounds (S1-1), (S1-2) and (S2-3) are specifically preferable.

The compound represented by Formula (S1) or Formula (S2) is one kind of electrolytic solvents, but may be used in combination with another solvent, as long as in an electrochemical display element of the present invention, the objective and effects of the present invention are not deteriorated. Specific examples of such solvents include tetramethylurea, sulfolane, dimethyl sulfoxide, 1,3-dimethyl-2-imidazolidinone, 2-(N-methyl)-2-pyrrolidinone, hexamethylphosphortriamide, N-methylpropioneamide, N,N-dimethylacetamide, N-methylacetamide, N,N-dimethylformamide, N-methylformamide, butyronitrile, propionitrile, acetonitrile, acetylacetone, 4-methyl-2-pentanone, 2-butanol, 1-butanol, 2-propanol, 1-propanol, ethanol, methanol, acetic anhydride, ethyl acetate, ethyl propionate, dimethoxy ethane, diethoxyfuran, tetrahydrofuran, ethylene glycol, diethylene glycol, triethylene glycol monobutyl ether, and water. Of these solvents described above, it is preferred to contain at least one solvent exhibiting a freezing point of not more than −20° C. and a boiling point of at least 120° C.

Further, other solvents usable in the present invention include compounds shown in, for example, J. A. Riddick, W. B. Bunger, T. K. Sakano, “Organic Solvents”, 4th ed., John Wiley & Sons (1986), Y. Marcus, “Ion Solvation”, John Wiley & Sons (1985), C. Reichardt, “Solvents and Solvent Effects in Chemistry”, 2nd ed., VCH (1988), G. J. Janz, R. P. T. Tomkins, “Nonaqueous Electorlytes Handbook”, Vol. 1, Academic Press (1972).

In the present invention, the electrolyte solvent may be a single kind or may be a mixture, however, a mixed solvent containing ethylene carbonate is preferable. The added amount of ethylene carbonate is preferably 10 mass % or more but 90 mass % or less. A mixed electrolyte solvent having a propylene carbonate/ethylene carbonate mass ratio of 7/3 to 3/7 is specifically preferable. When the propylene carbonate mass ratio is larger than 7/3, ionic conductivity of the electrolyte may become lower, resulting in decrease of response rate, while when it is smaller than 3/7, deposition of electrolyte tends to occur at a lower temperature.

### [Porous White Scattering Material Layer]

In the present invention, in view of obtaining more enhanced display contrast and reflectivity of a white display, a porous white scattering material layer containing a porous white scattering material may be provided.

The porous white scattering layer applicable to the present invention can be formed by coating and drying an aqueous admixture of water-compatible polymers, which are substantially insoluble in the electrolyte solvents, and white pigments.

The meaning of “being substantially insoluble in an electrolyte solvent” in the present invention is defined as a state where the dissolved amount per kg of an electrolyte solvent is 0-10 g in the temperature range between −20° C. and 120° C. Such a dissolved amount can be determined using any of the methods known in the art such as a mass measurement method or a component quantitative method employing a liquid chromatogram or a gas chromatogram.

In the present invention, a water soluble polymer and a polymer dispersed in an aqueous medium may be cited as a water-compatible polymer substantially insoluble in an electrolyte solvent.

Water-soluble polymers include proteins such as gelatin and gelatin derivatives; natural compounds such as cellulose derivatives, starch and gum Arabic; polysaccharides including dextran, pullulan, and carrageenan; and synthetic polymer compounds such as polyvinyl alcohol, polyethylene glycol, polyvinylpyrrolidone, acrylamide polymers, and derivatives thereof Gelatin derivatives include acetylated gelatin and phthalated gelatin. Polyvinyl alcohol derivatives include terminal alkyl group-modified polyvinyl alcohol and terminal mercapto group-modified polyvinyl alcohol. Cellulose derivatives include hydroxyethyl cellulose, hydroxypropyl cellulose, and carboxymethyl cellulose.

Further, compounds described in Research Disclosure and on pages 71-75 of JP-A 64-13546, and high water-absorptive polymers such as homopolymers of vinyl monomers having —COOM or —SO₃M (M being a hydrogen atom or an alkaline metal) and copolymers of these vinyl monomers with each other and other vinyl monomers (for example, sodium methacrylate, ammonium methacrylate, and potassium acrylate) may be employed, which are described in U.S. Pat. No. 4,960,681 and JP-A 62-245260. These binders may be employed in combination of two or more of them.

In the present invention, polyvinyl alcohol, polyethylene glycol and polyvinylpyrrolidone may be preferably employed.

Polymers dispersed in water based solvents include latexes such as natural rubber latex, styrene butadiene rubber, butadiene rubber, nitrile rubber, chloroprene rubber, and isoprene rubber; and heat curable resins which are prepared by dispersing, in water based solvents, polyisocyanate based, epoxy based, acryl based, silicone based, polyurethane based, urea based, phenol based, formaldehyde based, epoxy-polyamide based, melamine based, or alkyd based resins, or vinyl based resins. Of these polymers, it is preferable to employ water based polyurethane resins described in JP-A No. 10-76621.

The weight average molecular weight of the water-compatible polymer according to the present invention is preferably 10,000-2,000,000 and more preferably 30,000-500,000.

Examples of a white pigment applicable to the present invention include titanium dioxide (anatase or rutile), barium sulfate, calcium carbonate, aluminum oxide, zinc oxide, magnesium oxide, zinc hydroxide, magnesium hydroxide, magnesium phosphate, magnesium hydrogen phosphate, alkaline earth metal salts, talc, kaolin, zeolite, acid clay, glass, and organic compounds such as polyethylene, polystyrene, acrylic resins, ionomers, ethylene-vinyl acetate copolymeric resins, benzoguanamine resins, urea-formalin resins, melamine-formalin resins, or polyamide resins. These compounds may be used singly or in combination, and may also be used in a state where voids capable of varying refractive index are contained in particles.

In the present invention, of the above-described white particles, preferably used are titanium dioxide, specifically, titanium dioxide surface-treated with an inorganic oxide (e.g., Al₂O₃, AlO(OH), or SiO₂); and titanium dioxide which is further treated, in addition to the above surface treatment, with an organic compound such as trimethylol ethane, triethanolamine acetate, or trimethylcyclosilane.

Of these white particles, titanium oxide or zinc oxide is more preferably used from the viewpoint of coloring inhibition at high temperature and of reflectance of an element originated from the refractive index.

In the present invention, an aqueous mixture of a water-compatible polymer and a white pigment is preferably in a state in which the white pigment is dispersed in water using a commonly known dispersion method. The mixing ratio of the water-compatible polymer/white pigment is preferably 1-0.01 by volume, and more preferably 0.3-0.05 by volume.

The thickness of the porous white scattering material layer is preferably 5-50 μm and more preferably 10-30 μm.

As an alcohol-containing solvent, a compound having a high compatibility with, for example, methanol, ethanol and isopropanol is preferably used. The mixing ratio of water/alcohol-containing solvent is preferably 0.5-20 by mass and more preferably 2-10 by mass.

In the present invention, the medium to coat an aqueous mixture of a water-compatible polymer and a white pigment may be provided at any portion as far as it is in the constituting component between the opposing electrodes of the display element, however, it is preferably provided on the electrode surface of at least one of the opposing electrodes.

Examples of medium providing methods include a coating method; a liquid spray method; a spray method via a gas phase such as a system which ejects liquid droplets employing vibration of a piezoelectric element, e.g., a piezo-system ink-jet head; a BUBBLE JET (registered trademark) ink-jet head which ejects liquid droplets employing a thermal head utilizing bumping; and a spray method which sprays liquid via air or liquid pressure.

The coating method can be appropriately selected from commonly known coating methods, and examples thereof include an air doctor coater, a blade coater, a rod coater, a knife coater, a squeeze coater, an impregnation coater, a reverse roller coater, a transfer roller coater, a curtain coater, a double roller coater, a slide hopper coater, a gravure coater, a kiss roll coater, a bead coater, a cast coater, a spray coater, a calender coater and an extrusion coater.

Drying of the aqueous mixture of a water-compatible polymer and a white pigment provided on a medium may be carried out using any method as far as it is a method by which water can be evaporated. Examples thereof include heating via a heat source, a heating method using infrared radiation, and a heating method using electromagnetic induction. Further, water evaporation may be carried out under a reduced pressure.

The term “porous”, as described in the present invention, refers to the following state. The porous white scattering materials are formed by applying the above aqueous admixture of the water-compatible polymer and the white pigment to the electrode and subsequently drying the resulting coating, after which, an electrolyte, containing silver or a compound containing silver in its chemical structure, is provided onto the aforesaid scattering material. Then, the resulting scattering material is sandwiched between opposing electrodes. The above state is such that when electric potential is applied between the resulting opposing electrodes, it is possible to cause silver dissolution and deposition reaction, and refers to a penetration state in which ion species are movable between the electrodes.

In the display element according to the present invention, it is preferable that the water-compatible polymer in the above-described aqueous admixture is subjected to a hardening reaction employing a hardening agent during coating and drying thereof or after drying of the same.

Examples of hardening agents employed in the present invention include those described in the column 41 of U.S. Pat. Nos. 4,678,739, and 4,791,042, as well as JP-A Nos. 59-116655, 62-245261, 61-18942, 61-249054, 61-245153, and 4-218044. Specific hardening agents include aldehyde based hardening agents (such as formaldehyde), aziridine based hardening agents, epoxy based hardening agents, vinylsulfone based hardening agents (such as N,N′-ethylene-bis(vinylsulfonylacetamido)ethane), N-methylol based hardening agents (such as dimethylolurea), boric acid, metaboric acid, and polymer hardening agents (compounds described in documents such as JP-A No. 62-234157). In case where gelatin is employed as a water-based compound, of the above hardening agents, it is preferable to employ vinylsulfone type hardening agents or chlorotriazine type hardening agents individually or in combination thereof. Further, in case where polyvinyl alcohol is employed, it is preferable to employ boron-containing compounds such as boric acid and metaboric acid.

The amount of these hardening agents employed is 0.001 to 1 g per gram of the water-based compound, and preferably is 0.005 to 0.5 g. In order to increase layer strength, a heat treatment or humidity regulation during the hardening reaction may also be carried out.

### [Thickening Agents Added to the Electrolyte]

In the display element according to the present invention, it is possible to use thickening agents in the electrolyte layer. Examples include gelatin, gum Arabic, poly(vinyl alcohol), hydroxyethyl cellulose, hydroxypropyl cellulose, cellulose acetate, cellulose acetate butyrate, poly(vinylpyrrolidone), poly(alkylene glycol), casein, starch, poly(acrylic acid), poly(methylmethacrylic acid), poly(vinyl chloride), poly(methacrylic acid), copoly(styrene-maleic anhydride), copoly(styrene-acrylonitrile), copoly(styrene-butadiene), poly(vinyl acetals) (for example, poly(vinyl formal), poly(vinyl butyral)), poly(vinyl esters), poly(urethanes), phenoxy resins, poly(vinylidene chloride), poly(epoxides), poly(carbonates), poly(vinyl acetate), cellulose esters, poly(amides), as well as polyvinyl butyral, cellulose acetate, cellulose acetate butyrate, polyester, polycarbonate, polyacrylic acid, and polyurethane as a transparent hydrophobic binder.

These thickening agents may be employed in combinations of at least two types. Further listed are the compounds described on pages 71-75 of JP-A No. 64-13546. Of these, in view of compatibility with various types of additives and enhancement of dispersion stability of white particles, preferably employed compounds are polyvinyl alcohols, polyvinylpyrrolidones, hydroxypropyl celluloses, and polyalkylene glycols.

### <<Other Constitution Member of the Display Element>>

### (Electron Insulation Layer)

In an electrochemical display element of the present invention, an electron insulation layer can be provided.

The electron insulation layer applicable to the present invention may be a layer exhibiting ion conductivity together with electron insulation. Examples thereof include a solid electrolyte film for which a polymer or a salt having a polar group is prepared in the form of a film, a quasi-solid electrolyte film in which an electrolyte is supported in a porous film with high electron insulation and its pores, a polymer porous film having pores, and a porous body made of an inorganic material exhibiting low specific permittivity such as a silicon-containing compound.

As a method of forming a porous film, there can be used any of commonly known formation methods such as a firing method (a fusion method) (polymer fine particles or inorganic particles are added to a binder and partially fused, and then pores having been generated among particles are utilized), an extraction method (a constituent layer is formed of an organic or inorganic substance soluble in a solvent and a binder insoluble in the solvent, and then the organic or inorganic substance is dissolved with the solvent to obtain fine pores), a foaming method in which a polymer is allowed to foam by heating or degassing, a phase conversion method in which a mixture of polymers is phase-separated via manipulation of a good solvent and a poor solvent, or a radiation irradiation method to form fine pores via irradiation of various kinds of radiations. Specifically, there are listed electron insulation layers described in JP-A No. 10-30181 and JP-A No. 2003-107626, Japanese Patent Examined Publication No. 7-95403, Japanese Patent Publication No. 2635715, Japanese Patent Publication No. 2849523, Japanese Patent Publication No. 2987474, Japanese Patent Publication No. 3066426, Japanese Patent Publication No. 3464513, Japanese Patent Publication No. 3483644, Japanese Patent Publication No. 3535942, and Japanese Patent Publication No. 3062203.

### [Other Additives]

In the display element according to the present invention, listed as constitution layers include ancillary layers such as a protective layer, a filter layer, an antihalation layer, a cross-over light cutting layer, or a backing layer. If necessary, incorporated in these ancillary layers may be various chemical sensitizers, noble metal sensitizers, photosensitive dyes, supersensitizers, couplers, high boiling point solvents, antifoggants, stabilizers, development inhibitors, bleach acceleraters, fixing acceleraters, color mixing inhibitors, formalin scavengers, toners, hardeners, surface active agents, thickening agents, plasticizers, lubricants, UV absorbers, antirradiation dyes, filter light absorbing dyes, mildewcides, polymer latexes, heavy metals, antistatic agents, and matting agents.

The additives listed above are more detailed in Research Disclosure (hereinafter referred to as RD) Volume 176 Item/17643 (December 1978), RD Volume 184 Item/18431 (August 1979), DR Volume 187 Item/18716 (November 1979), and RD Volume 308 Item/308119 (December 1989).

Types of compounds and their citations in these three Research Disclosures are listed in following Table 1.

TABLE 1

| Additives | RD17643 | | RD18716 | RD308119 | |
|---|---|---|---|---|---|
| Items | Pages | Sections | Pages | Pages | Sections |
| Chemical | 23 | III | 648 upper right | 996 | III |
| sensitizers | | | | | |
| Sensitizing dyes | 23 | IV | 648, 649 | 996-998 | IV |
| Desensitizing dyes | 23 | IV | — | 998 | IV |
| Dyes | 25, 26 | VIII | 649, 650 | 1003 | VIII |
| Development | 29 | XXI | 648 upper right | — | — |
| accelerators | | | | | |
| Antifoggant | 24 | IV | 649 upper right | 1006, 1007 | VI |
| stabilizers | | | | | |
| Optical bright- | 24 | VIII | — | 998 | V |
| ening agents | | | | | |
| Hardeners | 26 | XXI | 651 left | 1004, 1005 | X |
| Surfactants | 26, 27 | XI | 650 right | 1005, 1006 | XI |
| Antistatic agents | 27 | XII | 650 right | 1006, 1007 | XIII |
| Plasticizers | 27 | XII | 650 right | 1006 | XII |
| Lubricants | 27 | XII | — | — | — |
| Matting agents | 28 | XVI | 650 right | 1008, 1009 | XVI |
| Binders | 26 | XXII | — | 1003, 1004 | IX |
| Supports | 28 | XVII | — | 1009 | XVII |

### [Substrate]

### <Transparent Substrate on the Display Side>

The substrate used in the present invention are preferably a transparent substrate. As such a transparent substrate, preferably usable are a polymer film made of polyester (for example, polyethylene terephthalate ans so forth), polyimide, methyl polymethacrylate, polystyrene, polypropylene, polyethylene, polyamide, nylon, polyvinyl chloride, polyvinylidene chloride, polycarbonate, polyether sulfone, a silicon resin, a polyacetal resin, a fluorine resin, a cellulose derivative or polyolefin; a plate substrate; a glass substrate: and so forth. The transparent substrate used in the present invention means a substrate exhibiting a transmittance of 50% or more with respect to visible light.

Further, an opaque substrate such as an inorganic substrate (for example, a metal substrate, a ceramic substrate and so forth) is usable for facing substrates.

### [Electrode]

In the display element of the present invention, the following electrodes are usable as opposing substrates.

### (Transparent Electrode on Display Side)

Of the opposing electrodes, the electrode provided on the display side is preferably a transparent electrode.

Transparent electrodes are not particularly limited as long as they are transparent and electrically conductive. Examples thereof include indium tin oxide (ITO: indium tin oxide), indium zinc oxide (IZO: indium zinc oxide), fluorine-doped tin oxide (FTO), indium oxide, zinc oxide, platinum, gold, silver rhodium, copper, chromium, carbon, aluminum, silicon, amorphous silicon, and BSO (bismuth silicon oxide).

Further, polythiophene, polypyrrole, polyaniline, polyacetylene, polyparaphenylene, polyselenophenylene, and a modification compound thereof can be used singly or in combination.

The surface resistance value is preferably 100 Ω/□ or less, and is more preferably 10 Ω/□ or less. The thickness of the transparent electrodes is not particularly limited, but is commonly 0.1-20 μm.

### (Transparentporous Electrode)

It is one of the features of the present invention that a nano porous electrode having a nano porous structure may be provided on the above-described transparent electrode. This nano porous electrode is substantially transparent when a display element is fabricated, and can carry an electrically active material such as an electrochromic dye.

The nano porous structure as mentioned in the present invention means that nano sized pores are infinitively existing in the layer, and the structure enables mobilization of ionic species contained in the electrolyte in the nano porous structure.

The formation methods of the nano-porous electrode according to the present invention include: a method in which a layer containing a material constituting the electrode and a solvent is formed via, for example, an inkjet method, a screen printing method and a blade coating method using a dispersion containing the material constituting the electrode, followed by forming a porous layer by heating, drying and sintering at a prescribed temperature to obtain porosity; and a method in which, after an electrode layer is formed via, for example, a sputtering method, a CVD method and an atmospheric pressure plasma method, a nano-porous layer is formed by an anode oxidation method or a photo-electrochemical etching method to obtain porosity. Also, a nano-porous electrode can be prepared via a sol-gel method or a method described in Adv. Mater. 2006, 18, 2980-2983.

The main component of the material which constitutes the nano-porous electrode according to the present invention can be selected from: metals such as Cu, Al, Pt, Ag, Pd, and Au; metal oxides such as ITO, SnO₂, TiO₂ and ZnO; and carbon electrodes such as carbon nano-tube, glassy carbon, diamond like carbon and nitrogen-containing carbon, and is preferably selected from metal oxides, such as ITO, SnO₂, TiO₂, and ZnO.

In order that the nano porous electrode exhibits transparency, particles having an average particle diameter of 5 nm-10 μm are preferably used. The shape of the particles may be any, such as, indeterminate, needle-like or spherical.

The thickness of the nano-porous electrode is preferably 0.1-10 μm and more preferably 0.25-5 μm.

### (Grid Electrode: Auxiliary Electrode)

In the present invention, an auxiliary electrode can be additionally provided to at least one of the facing electrodes.

A material exhibiting lower electrical resistivity than that of the electrode portion as a main portion is preferably used for the auxiliary electrode. Preferably usable examples thereof include metals such as platinum, gold, silver, copper, aluminum, zinc, nickel, titanium, bismuth and so forth, and their alloys.

An auxiliary electrode can be placed between the electrode portion as a main portion and a substrate, or placed on the surface on the opposite side of the substrate of the electrode portion as a main portion. At any rate, the auxiliary electrode may be electrically connected to the electrode portion as an auxiliary electrode.

The arrangement pattern of the auxiliary electrode is not specifically limited, but each pattern in the form of a line, a mesh or a circle is possible to be appropriately formed depending on performance to be desired. When the electrode portion as a main portion is divided into plural parts, divided electrode portions may be connected to each other. However, when the electrode portion as a main portion is provided on a substrate on the display side as a transparent electrode, the auxiliary electrode is desired to be provided in shape as well as in frequency so as not to inhibit visibility of a display element.

As a method of forming an auxiliary electrode, usable is a commonly known method. Examples thereof include patterning via photolithography, a printing method, an inkjet method, electrolytic plating, non-electrolytic plating, and a method of forming a pattern via a developing treatment after a light exposure process by using a silver salt photosensitive material.

The line width and line intervals of the auxiliary electrode may be arbitrary, but the line width should be wider in order to increase conductivity. On the other hand, when an auxiliary electrode is additionally provided to a transparent electrode, an area coverage ratio of the auxiliary electrode observed from the display element observation side is preferably 30% or less, and more preferably 10% or less in view of visibility.

The line width of the auxiliary electrode is 1 μm or more and preferably 100 μm or more, and the line interval is preferably from 50 μm to 1000 μm.

### (Method of Forming Electrode)

A commonly known method is usable for formation of a transparent electrode as well as a metal auxiliary electrode. For example, masked evaporation may be conducted on a substrate by a spattering method, or patterning via photolithography may be performed after forming the entire surface.

Further, an electrode is possible to be formed via electrolytic plating, non-electrolytic plating, printing or an inkjet method.

After forming an electrode pattern possessing a catalyst layer having monomer polymerizing ability on a substrate by an inkjet method, a monomer component, which is capable of forming an electrically conductive polymer layer via polymerization with the catalyst is provided to polymerize the monomer component, and further, and further, metal plating of such as silver plating is carried out on the electrically conductive polymer layer to form a metal electrode pattern. Since this employs no photo-resist or a mask pattern, processes can be largely simplified.

When forming an electrode material via a coating system, usable examples include commonly known methods such as a dipping method, a spinner method, a spray method, a roll coater method, a flexography method and a screen printing method and so forth.

The following electrostatic inkjet method among inkjet systems is possible to continuously print precisely with high viscosity liquid, and is preferably employed for formation of a transparent electrode as well as a metal auxiliary electrode of the present invention. The viscosity of ink is preferably 30 mPa·s or more, and more preferably 100 mPa·s or more.

### [Electrostatic Inkjet Method]

In a display element of the present invention, as one of preferred embodiments, at least one of a transparent electrode and a metal auxiliary electrode as a composite electrode is formed with a liquid ejection apparatus equipped with a liquid ejection head possessing a nozzle having an inner diameter of 30 μm or less to eject charged liquid, a supply means to supply a solution into the foregoing nozzle, and an ejection voltage applying means to apply an ejection voltage to the solution in the forgoing nozzle. Further, the electrode is preferably formed with an ejection apparatus equipped with a convex meniscus forming means in such a way that the solution in the foregoing nozzle rises in the form of a projected convex from the nozzle top.

Further, it is also preferable to use a liquid ejection apparatus equipped with an operation control means to control application of driving voltage of driving the convex meniscus and application of ejection voltage by an ejection voltage control means, and this operation control means equipped with the first ejection control section, which conducts application of drive voltage of the meniscus forming means during liquid drop ejection while applying ejection voltage by the foregoing ejection voltage applying means.

Further, it is also a preferable embodiment to use a liquid ejection apparatus equipped with an operation control means, which controls drive of the foregoing convex meniscus forming means and voltage application by an ejection voltage applying means, wherein this operation control means is provided with the second ejection control section, which synchronously performs the solution rising operation by the foregoing convex meniscus forming means and the foregoing ejection voltage application, and the foregoing operation control means is provided with a liquid surface stabilization control section, which performs rising operation of the foregoing solution and operation control to draw the liquid surface at the foregoing nozzle top to the inside after application of the ejection voltage.

It is effective to form an electrode pattern via such an electrostatic inkjet method, since an electrode exhibiting excellent on-demand capability, less generation of waste material in quantity, and excellent dimension accuracy can be prepared.

### [Others]

The display element of the present invention may optionally employ sealing agents, column-structure materials, and spacer particles.

Sealing agents are those to seal materials so that they do not leak out, and also called as a sealant. Usable are curing type, thermosetting type, photo-curing type, moisture curing type, and anaerobic curing type such as epoxy resins, urethane resins, acryl resins, vinyl acetate resins, ene-thiol resins, silicone resins, or modified polymer resins.

Columnar structure materials provide strong self-supporting (strength) between substrates. Examples thereof include a cylindrical form, a quadrangular form, an elliptic cyllindrical form and a trapezoidal form, which are arranged at definite intervals in a specified pattern such as a lattice. Further, there may be employed stripe-shaped ones arranged at definite intervals. It is preferable that the columnar structure materials are not randomly arranged, but arranged at equal intervals, arranged so as to vary the interval gradually, or arranged so as to repeat a predetermined pattern at a definite cycle so that the distance between substrates is appropriately maintained and image display is not hindered. When 1-40% of the display region of a display element is occupied by the columnar structure material, sufficient strength for commercial viability is achieved for a display element.

There may be provided a spacer between a pair of substrates to maintain a uniform gap between them. Examples of such a spacer include a spherical material composed of a resins or inorganic oxide. Further, adhesion spacers are suitably employed the surface of which is coated with thermoplastic resins. In order to maintain the uniform gap between substrates, there may be provided only columnar structure materials. However, there may be provided both spacers and columnar structure materials. In place of the columnar structure materials, only spacers may be employed as a space-holding member. The diameter of spacers, when a columnar structure material is formed, is not more than its height, and is preferably equal to the height. When no columnar structure material is formed, the diameter of spacers corresponds to the thickness of the cell gap.

### [Method of Driving Display Element]

A driving operation of the display element of the present invention may be a simple matrix drive or active matrix drive. The simple matrix drive referred to in the present invention refers to a driving method in which electrical current is sequentially applied to a circuit formed by vertically crossing of a positive line containing plural positive electrodes to a facing negative line containing plural negative electrodes. The use of such a simple matrix drive has the advantage that the circuit structure and the driving IC are capable of being simplified to reduce the production cost. The active matrix drive refers to a driving method using TFT circuits in which scanning lines, data lines, and current supplying lines are formed in a grid manner and the TFT circuits are positioned in each of the grids. The active matrix drive is advantageous in gradation and memory functions since a switching function can be allocated to each pixel. The circuit described, for example, in FIG. 5 of JP-A No. 2004-29327 is employable.

### (Application to Products)

The display element prepared by a method of manufacturing a display element of the present invention is applied to fields including electronically published books, ID cards, public use, transportation, broadcasting, financial clearance, and distribution and logistics. Specific examples thereof include door keys, student ID cards, employee ID cards, various membership cards, convenience store cards, department store cards, vending machine cards, gas station cards, subway and railroad cards, bus cards, cashing cards, credit cards, highway cards, driver's license cards, hospital consultation cards, electronic medical charts, health insurance cards, basic resident registers, passports and electronic books.

### EXAMPLES

The present invention will be specifically explained below with referring to examples, however, the present invention is not limited thereto. In the following examples, “part(s)” and “%” means “part(s) by mass” and “% by mass”, respectively, unless otherwise specified.

### <<Preparation of Electrolyte>>

### (Preparation of Electrolyte 1)

In 2.5 parts by mass of dimethyl sulfoxide, dissolved were 0.025 g of spiro tetrafluoroborate (1,1′)-bipyrrolidinium, 0.05 part by mass of carboxy TEMPO (4-carboxy-2,2,6,6-tetramethylpiperidine-1-oxyl free radical), 0.1 part by mass of silver p-toluenesulfonate, and 0.2 part by mass of exemplified compound G-19 (2-mercapto-benzimidazole) and 0.08 parts by mass of potassium hydroxide, followed by stirring to prepare electrolyte 1.

### (Preparation of Electrolyte 2)

Electrolyte 2 was prepared in the same manner as the preparation of electrolyte 1, except that 0.08 part by mass of potassium hydroxide was changed to 0.07 parts by mass of triethylamine.

### (Preparation of Electrolyte 3)

Electrolyte 3 was prepared in the same manner as the preparation of electrolyte 1, except that 0.08 part by mass of potassium hydroxide was changed to 0.10 part by mass of triethylamine.

### (Preparation of Electrolyte 4)

Electrolyte 4 was prepared in the same manner as the preparation of electrolyte 1, except that 0.08 part by mass of potassium hydroxide was changed to 0.14 part by mass of triethylamine.

### (Preparation of Electrolyte 5)

Electrolyte 5 was prepared in the same manner as the preparation of electrolyte 1, except that 0.08 part by mass of potassium hydroxide was changed to 0.21 part by mass of triethylamine.

### (Preparation of Electrolyte 6)

Electrolyte 6 was prepared in the same manner as the preparation of electrolyte 1, except that 0.08 part by mass of potassium hydroxide was changed to 0.28 part by mass of triethylamine.

### (Preparation of Electrolyte 7)

Electrolyte 7 was prepared in the same manner as the preparation of electrolyte 1, except that 0.08 part by mass of potassium hydroxide was changed to 0.2 part by mass of triethanolamine.

### (Preparation of Electrolyte 8)

Electrolyte 8 was prepared in the same manner as the preparation of electrolyte 1, except that 0.08 part by mass of potassium hydroxide was changed to 0.10 part by mass of POLYALLYLAMINE® PAA-01 (produced by NITTO BOSEKI Co., Ltd.)

### (Preparation of Electrolyte 9)

Electrolyte 9 was prepared in the same manner as the preparation of electrolyte 1, except that 0.08 part by mass of potassium hydroxide was changed to 1 part by mass of 3-(1-piperidino) propyl modified silica gel (introduction amount 1.1 mmol/g).

### (Preparation of Electrolyte 10)

Electrolyte 10 was prepared in the same manner as the preparation of electrolyte 1, except that 0.08 part by mass of potassium hydroxide was not used.

### (Preparation of Electrolyte 11)

Electrolyte 11 was prepared in the same manner as the preparation of electrolyte 1, except that 0.08 part by mass of potassium hydroxide was changed to 0.2 part by mass of potassium hydroxide.

### (Preparation of Electrolyte 12)

Electrolyte 12 was prepared in the same manner as the preparation of electrolyte 4, except that exemplified compound G-19 was changed to exemplified compound G-18.

### (Preparation of Electrolyte 13)

Electrolyte 13 was prepared in the same manner as the preparation of electrolyte 4, except that exemplified compound G-19 (2-mercaptobenzimidazole) was not used.

### (Preparation of Electrolyte 14)

Electrolyte 14 was prepared in the same manner as the preparation of electrolyte 9, except that exemplified compound G-19 was changed to exemplified compound G-18.

### (Preparation of Electrolyte 15)

Electrolyte 15 was prepared in the same manner as the preparation of electrolyte 9, except that exemplified compound G-19 (2-mercaptobenzimidazole) was not used. (Measurement of the acidity of each electrolyte)

In each of electrolytes 1-15, the same amount of pure water was added, followed by stirring. The pH value of the water phase of the resulting liquid was measured at 25° C. with a digital pH meter HM-305 produced by DKK-TOA Corporation. The pH value obtained as above was designated as the “acidity”. As for display device 10, electrolyte 10′ containing POLYALLYLAMINE® PAA-01 (produced by NITTO BOSEKI Co., Ltd.) which was initially added to the sealant of a cell, which was then diffused and incorporated into the electrolyte, was obtained from the disassembled cell after electrolyte 10 was poured into an unfilled cell, followed by leaving for 1 hour. The acidity of electrolyte 10 was determined as described above. Obtained results were listed in Table 2 which will be shown below.

### <<Preparation of Electrode>>

### (Preparation of Electrode 1)

An ITO (Indium Tin Oxide) film having a pitch of 145 μm and a width of 130 wn was formed as an electrically conductive layer on a 2 cm×4 cm glass substrate having a thickness of 1.5 mm by a commonly known method to prepare electrode 1.

### (Preparation of Electrode 2)

A titanium dioxide film (about 4-10 particles having an average particle diameter of 17 nm, having been subjected to necking) having a thickness of Sum was further formed on electrode 1 to obtain electrode 2.

### (Preparation of Electrode 3)

After electrode 2 was dipped in following treatment liquid 1, followed by leaving for 1 hour at an ambient temperature, it was washed with ethanol and water. Then, the resulting electrode was heated at 100° C. for 1 hour, and allowed to be cooled. Subsequently, following treatment liquid 2 was applied so that the added amount on the titanium dioxide layer was 100 mg/cm², and the resulting electrode was left for 3 hours at an ambient temperature, followed by washing with ethanol and water, to prepare electrode 3.

### <Preparation of Treatment Liquid 1>

While stirring 20 g of pure water, 0.1 g of 3-aminopropyltrimethoxysilane was added dropwise, and further stirred for 1 hour at an ambient temperature to prepare treatment liquid 1.

### <Preparation of Treatment Liquid 2>

In 1.0 g of dimethylformamide, 0.025 g of exemplified compound (L1) as an EC compound, and 0.032g of 1-ethyl-3-(3-dimethylaminopropyl) carbodiimide hydrochloride were dissolved to prepare treamtment liquid 2.

### (Preparation of Electrode 4)

Exemplified compound (L18) was dissolved in acetonitrile so that the concentration is 3 mmoVL to prepare treatment liquid 3.

Above prepared electrode 2 was dipped in treatment liquid 3, left for 1 hour at an ambient temperature, washed with ethanol and water, heated at 100° C. for 1 hour, and allowed to cool, whereby electrode 4 was prepared.

### (Preparation of Electrode 5)

While stirring 0.02 part by mass of acetic acid, 1.0 part by mass of pure water, and 1.0 part by mass of methanol, a solution in which 0.01 part by mass of exemplified compound (L26) was dissolved in 0.15 part by mass of methanol was added dropwise, followed by stirring for 1 hour, to prepare treatment liquid 4.

Above treatment liquid 4 was applied on the titanium dioxide layer of above electrode 2 so that the added amount was 100 mg/cm², the resulting electrode was left for 1 hours at an ambient temperature, washed with ethanol and water, and subsequently heated at 100° C. for 1 hour to prepare electrode 5.

### (Preparation of Electrode 6)

On electrode 1, the following titanium dioxide dispersion was screen-printed so as to give a dry average film thickness of 20 μm. Thereafter, drying was conducted at 50° C. for 30 minutes to vaporize a solvent, and, subsequently, further dried at 85° C. for one hour to prepare electrode 6 in which a porous white scattering layer was formed on electrode 1.

### <Preparation of Titanium Dioxide Dispersion>

In a 1:1 mixed solution of water and ethanol, KURARAY POVAL PVA235 (polyvinyl alcohol resin, produced by KURARAY Co., Ltd.) was added so that the solid content was 2% by mass, and heated to dissolve. Thereafter, titanium dioxide CR-90 (produced by ISHIHARA SANGYO KAISHA, LID.) was added so that the solid content was 20% by mass, followed by dispersion with an ultrasonic homogenizer, to obtain a titanium dioxide dispersion.

### <<Preparation of Display Element>>

### (Preparation of Display Element 1)

The periphery of electrode 6 was rimmed with an olefin based sealant containing 10% as a volume fraction of glass-made spherical beads having an average particle diameter of 40 μm, and electrode 3 and electrode 6 as electrodes in the form of a stripe were subsequently attached so as to be normal to each other to prepare an empty cell further via heat-pressing. Electrolyte 1 was vacuum-injected into the empty cell, and the inlet was sealed with a UV curable epoxy resin to prepare display element 1.

### (Preparation of Display Elements 2-8)

Display elements 2-8 were prepared in the same manner as the preparation of display element 1 except that electrolytes 2-8, respectively, were used instead of electrolyte 1.

### (Preparation of Display Element 9)

The periphery of electrode 6 was rimmed with an olefin based sealant containing 10% as a volume fraction of plastic-made spherical beads having an average particle diameter of 150 μm, and electrode 3 and electrode 6 as electrodes in the form of a stripe were subsequently attached so as to be normal to each other to prepare an empty cell further via heat-pressing. Electrolyte 9 was vacuum-injected into the empty cell, and the inlet was sealed with a UV curable epoxy resin to prepare display element 9.

### (Preparation of Display Element 10)

The periphery of electrode 6 was rimmed with an olefin based sealant containing 10% as a volume fraction of plastic-made spherical beads having an average particle diameter of 150 μm and 10% of POLYALLYLAMINE® PAA-01 (produced by NITTO BOSEKI Co., Ltd.), and electrode 3 and electrode 6 as electrodes in the form of a stripe were subsequently attached so as to be normal to each other to prepare an empty cell further via heat-pressing. Electrolyte 10 was vacuum-injected into the empty cell, and the inlet was sealed with a UV curable epoxy resin to prepare display element 8.

### (Preparation of Display Elements 11 and 12)

Display elements 11 and 12 were prepared in the same manner as the preparation of display element 1 except that electrolytes 10 and 11, respectively, were used instead of electrolyte 1.

### (Preparation of Display Elements 13 and 14)

Display elements 13 and 14 were prepared in the same manner as the preparation of display element 1 except that electrolytes 12 and 13, respectively, were used instead of electrolyte 1.

### (Preparation of Display Elements 15 and 16)

Display elements 15 and 16 were prepared in the same manner as the preparation of display element 9 except that electrolytes 14 and 15, respectively, were used instead of electrolyte 1.

### (Preparation of Display Elements 17 and 18)

Display elements 17 and 18 were prepared in the same manner as the preparation of display element 4 except that electrodes 4 and 5, respectively, were used instead of electrode 3.

### <<Evaluation of the Display Elements>>

### [Display Speed]

The reflectance at maximum absorbing wavelength in the visible region (Rc) when the prepared display element was connected to the both terminals of a constant voltage power source and a voltage of +1.5V was applied to the display side electrode for 0.5 second to display a color, and the reflectance at the same wavelength when white is displayed (Rw) were measured using spectrophotometer CM-3700d (produced by Konica Minolta Sensing, Inc.), and the value of Rc/Rw was used as an index of the display speed. The display speed becomes faster when this value becomes smaller.

The main constitution and the obtained evaluation result of each display element were shown in Table 2.

TABLE 2

| Display | Electrolytes | | | | | Electrode constructions | | | Evaluation | |
|---|---|---|---|---|---|---|---|---|---|---|
| element | | | Acidity adjusting means | | | Display side | | Non-display | Display | |
| No. | No. | Acidity | Kinds | Adding portions | Formula (G) | No. | Formula (L) | side No. | speed Rc/Rw | Remarks |
| 1 | 1 | 7.2 | KOH | Electrolyte | G-19 | Electrode 3 | L1 | Electrode 6 | 0.24 | Inv. |
| 2 | 2 | 5.1 | TEA | Electrolyte | G-19 | Electrode 3 | L1 | Electrode 6 | 0.22 | Inv. |
| 3 | 3 | 6.1 | TEA | Electrolyte | G-19 | Electrode 3 | L1 | Electrode 6 | 0.17 | Inv. |
| 4 | 4 | 7.0 | TEA | Electrolyte | G-19 | Electrode 3 | L1 | Electrode 6 | 0.13 | Inv. |
| 5 | 5 | 7.9 | TEA | Electrolyte | G-19 | Electrode 3 | L1 | Electrode 6 | 0.13 | Inv. |
| 6 | 6 | 8.9 | TEA | Electrolyte | G-19 | Electrode 3 | L1 | Electrode 6 | 0.18 | Inv. |
| 7 | 7 | 7.1 | TEOHA | Electrolyte | G-19 | Electrode 3 | L1 | Electrode 6 | 0.12 | Inv. |
| 8 | 8 | 6.9 | PAA | Electrolyte | G-19 | Electrode 3 | L1 | Electrode 6 | 0.13 | Inv. |
| 9 | 9 | 7.0 | *1 | Electrolyte | G-19 | Electrode 3 | L1 | Electrode 6 | 0.04 | Inv. |
| 10 | 10 | 6.7 | PAA | Sealant | G-19 | Electrode 3 | L1 | Electrode 6 | 0.07 | Inv. |
| 11 | 10 | 4.1 | — | — | G-19 | Electrode 3 | L1 | Electrode 6 | 0.35 | Comp. |
| 12 | 11 | 11.3 | KOH | Electrolyte | G-19 | Electrode 3 | L1 | Electrode 6 | unmeasurable | Comp. |
| 13 | 12 | 7.0 | TEA | Electrolyte | G-18 | Electrode 3 | L1 | Electrode 6 | 0.14 | Inv. |
| 14 | 13 | 7.0 | TEA | Electrolyte | — | Electrode 3 | L1 | Electrode 6 | 0.31 | Comp. |
| 15 | 14 | 7.0 | *1 | Electrolyte | G-18 | Electrode 3 | L1 | Electrode 6 | 0.05 | Inv. |
| 16 | 15 | 7.0 | *1 | Electrolyte | — | Electrode 3 | L1 | Electrode 6 | 0.29 | Comp. |
| 17 | 4 | 7.0 | TEA | Electrolyte | G-19 | Electrode 4 | L18 | Electrode 6 | 0.12 | Inv. |
| 18 | 4 | 7.0 | TEA | Electrolyte | G-19 | Electrode 5 | L26 | Electrode 6 | 0.13 | Inv. |

TEA: Triethylamine,
TEOHA: Triethanolamine,
PAA: POLYALLYLAMIINE ®,
*1: 3-(1-piperidino) propyl modified silica gel,
Inv.: Inventive,
Comp.: Comparative

As is clear from the results shown in Table 2, the display element meeting the constitution prescribed by the present invention exhibited a higher rewriting speed from a white display to a color display than that of a comparative example.

1. A display element comprising at least an electrolyte and a compound represented by following Formula (L) between opposing electrodes, wherein
the electrolyte comprises a metal salt compound and a mercapto compound represented by following Formula (G),
an acidity of the electrolyte is 5.0 or more but 9.0 or less, the acidity of the electrolyte being defined as a pH value measured at 25° C. of a water phase obtained by adding the same amount of pure water as an amount of the electrolyte to the electrolyte, followed by stirring, and
a white display, a black display and a color display other than the black display are conducted by a driving operation employing the opposing electrodes: 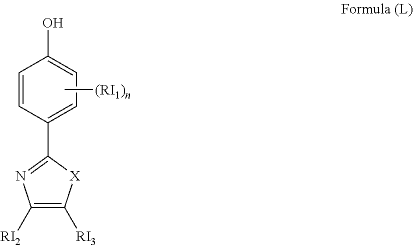
wherein Rl₁ represents a halogen atom, an aliphatic group, an aliphatic oxy group, an acylamino group, a carbamoyl group, an acyl group, a sulfonamide group or a sulfamoyl group, n represents an integer of 1 to 4, Rl₂ represents an aromatic group or an aromatic heterocycle group, and Rl₃ represents a hydrogen atom, an aliphatic group, an aromatic group or an aromatic heterocycle group, and X represents >N-Rl₄, an oxygen atom or a sulfur atom, wherein Rl₄ represents a hydrogen atom, an aliphatic group, an aromatic group, a heterocycle group or an acyl group,
wherein a group represented by one of Rl₁ to Rl₄ may further be substituted by an arbitrary substituent, and 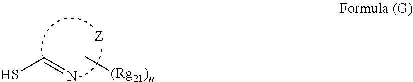
wherein Z represents a heterocycle containing nitrogen, n represents an integer of 0 to 5, and Rg₂₁ represents a halogen atom, an alkyl group, an aryl group, an alkyl carbonamide group, an aryl carbonamide group, an alkyl sulfonamide group, an aryl sulfonamide group, an alkoxy group, an aryl oxygroup, an alkylthio group, an aryl thio group, an alkyl carbamoyl group, an aryl carbamoyl group, a carbamoyl group, an alkyl sulfamoyl group, an aryl sulfamoyl group, a sulfamoyl group, a cyano group, an alkyl sulfonyl group, an aryl sulfonyl group, an alkoxy carbonyl group, an aryl oxycarbonyl group, an alkyl carbonyl group, an aryl carbonyl group, an acyloxy group, a carboxyl group, a carbonyl group, a sulfonyl group, an amino group, a hydroxy group or a heterocycle group, wherein, when n is 2 or more, the Rg₂₁ groups may be the same or different, and may be combined with each other to form a condensed ring.

2. The display element of claim 1, wherein the acidity of the electrolyte is 6.0 or more but 8.0 or less.

3. The display element of claim 1, wherein the display element comprises a compound represented by Formula (A) between the opposing electrodes: 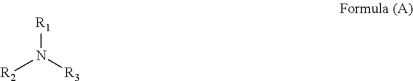
wherein R₁, R₂ and R₃ each represent a substituted or non-substituted hydrocarbon group, wherein R₁, R₂ and R₃ may be the same or different.

4. The display element of claim 1, wherein the display element comprises a polymer having an amino group between the opposing electrodes.

5. The display element of claim 1, wherein the display element comprises an amine compound carried on particles between the opposing electrodes.

6. The display element of claim 1, wherein
at least one of a compound represented by Formula (A), a polymer having an amino group and an amine compound carried on particles is fixed at an area other than surfaces of the opposing electrodes: 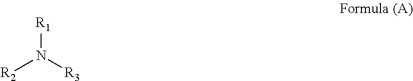
wherein R₁, R₂ and R₃ each represent a substituted or non-substituted hydrocarbon group, wherein R₁, R₂ and R₃ may be the same or different.
